(19) United States
(12) Patent Application Publication
(10) Pub. No.: US 2024/0406985 A1
(43) Pub. Date: Dec. 5, 2024

(54) Sidelink Carrier Aggregation

(71) Applicant: Fraunhofer-Gesellschaft zur Förderung der angewandten Forschung e.V., München (DE)

(72) Inventors: Sarun SELVANESAN, Berlin (DE); Baris GÖKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/804,508

(22) Filed: Aug. 14, 2024

Related U.S. Application Data
(63) Continuation of application No. PCT/EP2023/053947, filed on Feb. 16, 2023.

(30) Foreign Application Priority Data
Feb. 18, 2022 (EP) 22157568.1

(51) Int. Cl. H04W 72/40; H04L 5/00; H04W 72/02; H04W 72/0453; H04W 72/0457; H04W 72/20

(52) U.S. Cl. CPC H04W 72/40; H04L 5/001; H04W 72/02; H04W 72/0453; H04W 72/0457; H04W 72/20

(57) ABSTRACT

Embodiments provide a transceiver of a wireless communication network [e.g., 5G/new radio mobile communication network], wherein the transceiver is configured to transmit and/or receive a signal via a sidelink of the wireless communication network in a [e.g., 5G/new radio] virtual resource pool of the sidelink, the virtual resource pool comprising a plurality [e.g., two or more] of component carriers and/or a two or more resource pools.

### CROSS-REFERENCE TO RELATED APPLICATIONS

This application is a continuation of copending International Application No. PCT/EP2023/053947, filed Feb. 16, 2023, which is incorporated herein by reference in its entirety, and additionally claims priority from European Application No. EP 22157568.1, filed Feb. 18, 2022, which is also incorporated herein by reference in its entirety.

Embodiments of the present application relate to the field of wireless communication, and more specifically, to sidelink carrier aggregation.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside units (RSUs) or roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or 20 assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e., connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

Although FIGS. 2 to 5 illustrate vehicular UEs, it is noted that the described in-coverage and out-of-coverage scenarios also apply for non-vehicular UEs. In other words, any UE, like a hand-held device, communicating directly with another UE using sidelink channels may be in-coverage and out-of-coverage.

In a communication system as described above with reference to FIGS. 2 to 5, the maximum data rate for the sidelink is defined according to TS 38.306 V16.5.0, 4.1.5 [1] as:

$$data rate ( in Mbps ) = {10}^{- 6} \cdot {v}_{L a y e r s} \cdot {Q}_{m} \cdot f \cdot {R}_{max} \cdot \frac{{N}_{P R B}^{BW , μ} \cdot 12}{{T}_{s}^{μ}} \cdot ( 1 - O H )$$

Given a single sidelink carrier with a maximum of 40 MHz bandwidth, maximum 2-layer transmission, and 256-QAM for Rel-16/17, it can only support a maximum data rate of approx. 400 Mbps.

However, V2X use cases define sensor sharing applications which may need 700-1000 Mbps and high reliability which cannot be achieved with NR V2X Rel-16 or Rel-17.

Thus, starting from the above, there is a need for improvements or enhancements with respect to the capacity on the NR sidelink.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a wireless communication network, wherein the transceiver is configured to transmit and/or receive a signal via a sidelink of the wireless communication network in a virtual resource pool of the sidelink, the virtual resource pool having a plurality of component carriers and/or a two or more resource pools, wherein the transceiver is configured to transmit a first type of information using a first component carrier or virtual resource pool or virtual bandwidth part and to simultaneously transmit or receive at least a part of a second type of information using a second component carrier or virtual resource pool or virtual bandwidth part, wherein the first type of information is feedback information, wherein the second type of information is feedback information.

According to another embodiment, a method for transmitting or receiving signals in a wireless communication network may have the steps of: transmitting or receiving a signal via a sidelink of the wireless communication network in a virtual resource pool of the sidelink, the virtual resource pool having a plurality of component carriers and/or two or more resource pools, wherein a first type of information is transmitted using a first component carrier or virtual resource pool or virtual bandwidth part and at least a part of a second type of information is simultaneously transmitted or received using a second component carrier or virtual resource pool or virtual bandwidth part, wherein the first type of information is feedback information, wherein the second type of information is feedback information.

Another embodiment may have a non-transitory digital storage medium having a computer program stored thereon to perform the inventive method for transmitting or receiving signals in a wireless communication network, when said computer program is run by a computer.

### BRIEF DESCRIPTION OF THE DRAWINGS

Embodiments of the present invention will be detailed subsequently referring to the appended drawings, in which:

FIG. 1(a) is a core network 102 and one or more radio access networks RAN1, RAN2, . . . RANN;

FIG. 1(b) is a schematic representation of an example of a radio access network RANn;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation different carrier aggregation modes in LTE;

FIG. 7 is a schematic representation of a wireless communication system comprising a transceiver, like a base station or a relay, and a plurality of communication devices, like UEs, according to an embodiment;

FIG. 8a shows a schematic representation of a virtual resource pool including two or more resource pools, such as a first resource pool and a second resource pool;

FIG. 8b shows a schematic representation of a virtual resource pool including two or more resource pools, such as a first resource pool and a second resource pool;

FIG. 8c shows a schematic representation of a virtual resource pool including two or more resource pools, such as a first resource pool and a second resource pool, wherein each of the two or more resource pools can include one or more bandwidth parts,

FIG. 9 shows a schematic representation of linked resource pools;

FIG. 10a shows a schematic representation of a virtual resource pool including two or more resource pools, such as a first resource pool and a second resource pool;

FIG. 10b shows a schematic representation of a resource pool including two or more bandwidth parts, such as a first bandwidth part and a second bandwidth part;

FIG. 10c shows a schematic representation of a virtual bandwidth part including two or more bandwidth parts, such as a first bandwidth part and a second bandwidth part;

FIG. 10d shows a schematic representation of a bandwidth part including two or more component carriers, such as a first component carrier and a second component carrier;

FIG. 10e shows a schematic representation of a virtual component carrier including two or more component carriers, such as a first component carrier and a second component carrier;

FIG. 10f shows a schematic representation of carriers that overlap in the frequency domain but not in the time domain;

FIG. 11 shows a schematic representations of an exemplary component carrier switching performed by a UE in dependence on a switching criterion;

FIG. 12a shows a schematic representation of a component carrier switching performed by a UE under consideration of a respective switching time;

FIG. 12b shows a schematic representation of a component carrier switching performed by a UE under consideration of a respective switching time and in dependence on a switching criterion;

FIG. 13 shows a schematic representation of a component carrier switching performed by a UE under consideration of respective switching times with a fallback to a specific component carrier when a fallback criterion is fulfilled;

FIG. 14 shows a schematic representation of a simultaneous sensing on three component carriers and a transmission on one of the three component carriers in dependence on the sensing results and/or in dependence on a component carrier selection criteria;

FIG. 15 shows a schematic representation of a simultaneous sensing on two component carriers and a transmission on a third component carrier for which random resource selection is configured;

FIG. 16a shows a schematic representation of an inter-band carrier aggregation with simultaneous transmission on two component carriers in frequency regions FR1 and FR2;

FIG. 16b shows a schematic representation of an inter-band carrier aggregation with simultaneous transmission and reception on two component carriers in frequency regions FR1 and FR2;

FIG. 16c shows a schematic representation of an inter-band carrier aggregation with simultaneous transmission and sensing on two component carriers in frequency regions FR1 and FR2;

FIG. 17a shows a schematic representation of carrier aggregation of first and second component carriers, wherein the first component carrier is used for a transmission of control information, and wherein the second component carrier is used for a transmission of data;

FIG. 17b shows a schematic representation of carrier aggregation of first and second component carriers, wherein the first component carrier is used for a transmission of control information and optionally of data, wherein the first component carrier points to the second component carrier which is used for a transmission of data;

FIG. 18 shows a schematic representation of a carrier aggregation of first and second component carriers, wherein an ongoing transmission on the first component carrier is terminated after completion of a transmission of data on the second component carrier; and

FIG. 19 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

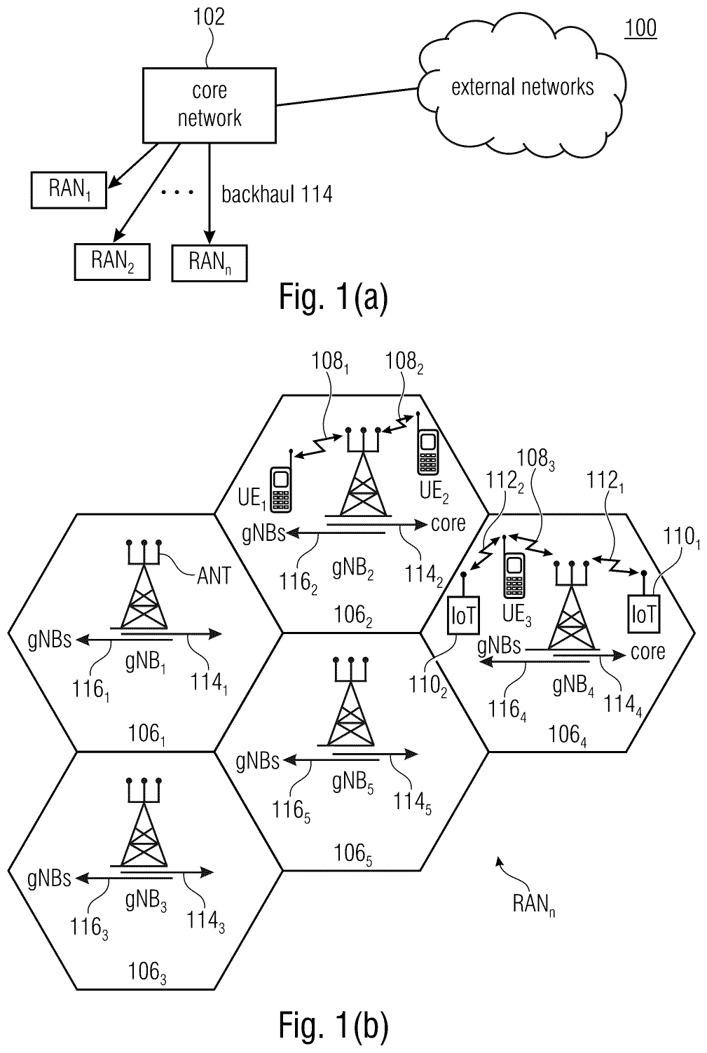

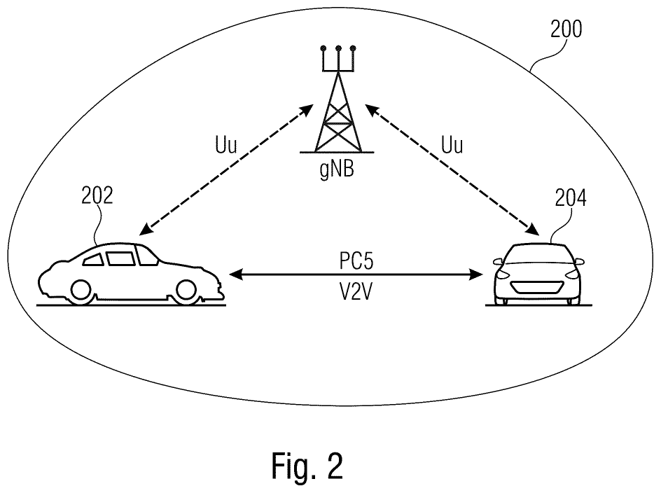

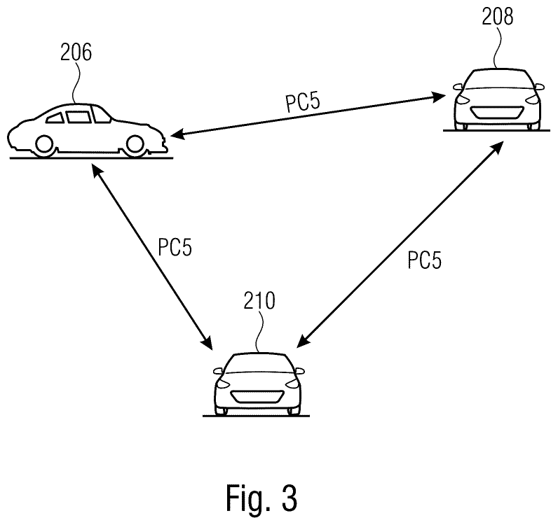

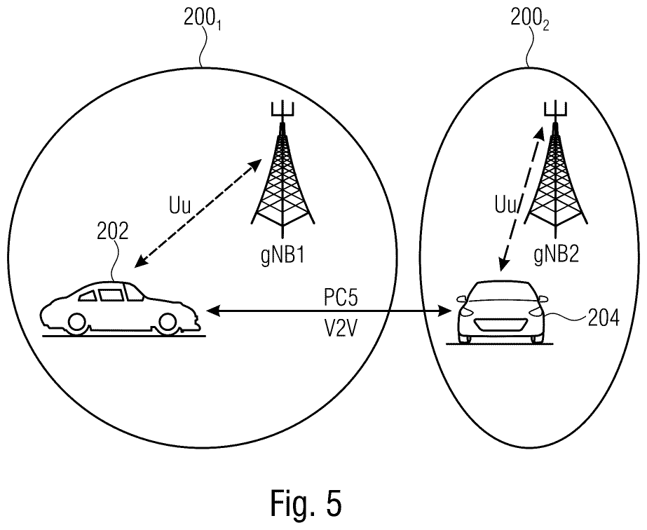

In the wireless communication system or network, like the one described above with reference to FIGS. 1-5, a sidelink communication among the respective user devices may be implemented, for example, a vehicle-to-vehicle communication, V2V, a vehicle-to-anything communication, V2X, or any device-to-device communication, D2D, among any other use devices, for example, those mentioned above. Furthermore, sidelink communication is not limited to vehicles but can also involve pedestrian UEs (P-UEs). Note that P-UEs may have a more stringent power saving demand, since these are typically handheld devices with a limited battery supply, compared to vehicles, which may have less stringent power saving requirements wrt. the air interface, since these have a either a large battery or have other means to generate power supply for the air interface.

Although in the following it is referred to V2X communications by way of example, it is noted that embodiments of the present invention also can be applied to other sidelink communications, such as V2V or D2D communications or 802.11p or other WiFi standards from the 802.11-family or Bluetooth.

The initial vehicle-to-everything (V2X) specification was included in Release 14 of the 3GPP standard. The scheduling and assignment of resources have been modified according to the V2X requirements, while the original device-to-device (D2D) communication standard has been used as the basis of the design. Release 15 of the LTE V2X standard (also known as enhanced V2X or eV2X) was completed in June 2018, and Release 16, the first release of 5G NR V2X, was completed in March 2020. Release 17 focuses on sidelink enhancements, with emphasis on power saving, enhanced reliability and reduced latency, to cater to not only vehicular communications, but also public safety and commercial use cases.

One way to further enhance the capacity on the NR sidelink is to introduce carrier aggregation (CA). The idea is to include at least aggregating licensed/ITS carriers in FR1 with the support for inter-band and intra-band carrier aggregation for NR Rel-18. Furthermore, it is open whether to also support CA for other carriers, e.g., unlicensed and/or FR2.

SL CA can further boost capacity on the NR sidelink.

TS 38.306 V16.5.0, 4.1.5 [1] defines the maximum data rate for the sidelink as:

$$data rate ( in Mbps ) = {10}^{- 6} \cdot {v}_{L a y e r s} \cdot {Q}_{m} \cdot f \cdot {R}_{max} \cdot \frac{{N}_{P R B}^{BW , μ} \cdot 12}{{T}_{s}^{μ}} \cdot ( 1 - O H )$$

Given a single sidelink carrier with a maximum of 40 MHz bandwidth, maximum 2-layer transmission, and 256-QAM for Rel-16/17, it can only support a maximum data rate of approx. 400 Mbps. V2X use cases define sensor sharing applications which may need 700-1000 Mbps and high reliability which cannot be achieved with NR V2X Rel-16 or Rel-17.

### 1. BACKGROUND

Sidelink carrier aggregation (CA) was introduced in LTE Rel-15, which also includes packet duplication. Packet duplication is typically performed on PDCP layer. LTE Uu started to support CA in LTE Rel-10 with up to 5 component carriers allowing transmission bandwidth of up to 100 MHz. In later releases, this was increased to up to 32 component carriers with up to 650 MHz bandwidth. While the signal processing capabilities scale quite well with the increased bandwidth, the RF implementation complexity can vary quite a lot, depending on the CA mode, bandwidth and carrier frequencies involved.

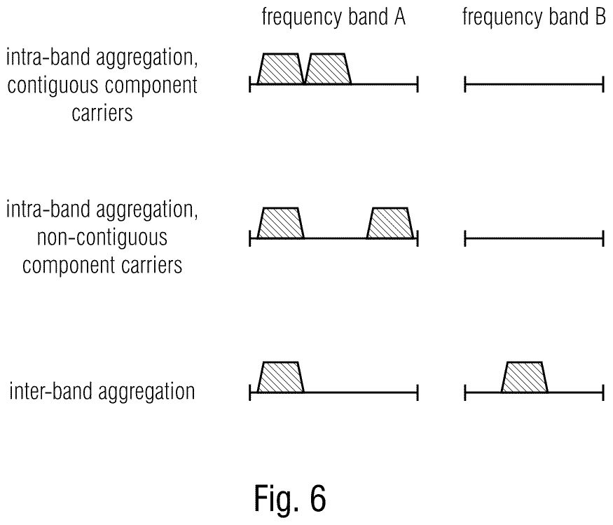

LTE CA supported intra-band, inter-band as well as contiguous and non-contiguous carrier aggregation, which is depicted in FIG. 6.

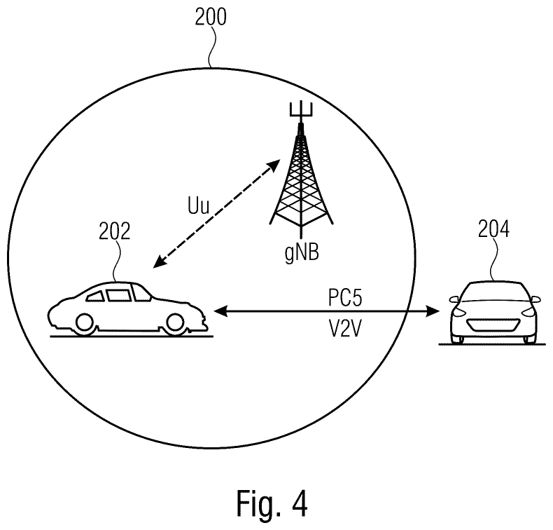

In detail, FIG. 6 shows different carrier aggregation modes in LTE [Dahlman/Parkvall/Sköld 5G NR book: FIG. 4.3]. As shown in FIG. 6, LTE supports intra-band aggregation of continuous component carriers of frequency band A, intra-band aggregation of non-continuous component carriers of frequency band A, and inter-band aggregation of frequency bands A and B.

### 1.1 NR Bandwidth Part

NR can operate across carriers due to its bandwidth part (BWP) concept in a contiguous or non-contiguous way. This is even without the configuration of carrier aggregation (CA). In Uu, up to 4 BWPs can be configured for DL or UL, but only a single BWP can be active at any given time instance per carrier. Since a BWP is defined by contiguous set of physical resource blocks, selected from a contiguous subset of the common resource blocks for a given numerology (u) on a given carrier, only a single numerology can be used by a UE at a given time instance per carrier. In sidelink, the BWP contains one or more resource pools that are configured or pre-configured. These resource pools will take on the same characteristics in terms of the subcarrier spacing as the BWP. If a UE is operating in two very different frequency bands, e.g., in FR1 and FR2, it might want to transmit data faster on the FR2 connection, since the link on an FR2 band could be seen as less stable. Thus, introducing CA in the V2X sidelink would allow for a larger mix of applications with different requirements, which could then operate in parallel, as will become clear from the description of section 2 below.

### 1.2 NR Carrier Aggregation

NR CA was already specified in the basic design of NR Rel-15. NR adopts LTEs CA principles and allows to aggregate up to 16 CCs with 400 MHz each, resulting in a net bandwidth of up to 6.4 GHz. Note that the combination of inter-band aggregation and half-duplex TDD carriers highlights the flexibility of NR systems. Furthermore, this also implies that carrier aggregation does not have to be the same for different transmission directions.

In the NR specification, carrier aggregation is referred to as primary cell (PCell) and one or more secondary cells (SCells). The SCell can be activated/deactivated on demand, according to the traffic requirements. Typically, control and feedback data would be transmitted on the PCell, whereas user data could be transmitted on the PCell as well as on the one or more SCells.

### 1.3 Carrier Aggregation in LTE V2X

As already indicated above, carrier aggregation was first introduced in V2X in LTE Rel-15. It was assumed that higher layers would provide a UE with a single carrier for its transmission. The carrier would be selected based on the CBR and the UE capability, such as the number of TX chains, implementation related aspects such as power budget sharing capability, TX chain retuning capability. The limited TX capability would mean that the UE could not support transmissions over carriers in a subframe due to
a) The number of TX chains being smaller than the number of configured TX carriers or,
b) The UE not supporting the given band combination or,
c) The TX chain switching time or,
d) The UE not fulfilling the RF requirement due to, e.g., PSD imbalance.

For a UE with limited TX capability for a), b) or c), when the UE performs the resource selection for a certain carrier, either by sensing or random resource selection, any subframe of that carrier shall be excluded from the reported candidate resource set if using that subframe exceeds its TX capability limitation under the given resource reservation in the other carriers. For a UE with limited TX capability for d), if the per-carrier independent resource selection leads to transmissions beyond the TX capability of the UE in a subframe, either by sensing or random resource selection, UE re-does resource reselection within the given reported candidate resource set until the resultant transmission resources can be supported by the UE. If there is overlap in one TTI and UE is not able to transmit simultaneously on multiple carrier due to limitation in available power, then the UE should prioritize transmission on higher priority packets.

If there is overlap in one TTI of same priority packets in different carriers then it should be left up to UE implementation to perform transmission if it is constrained in terms of available power.

The same selected carrier would be used for all MAC PDUs of the same sidelink process at least until resource reselection is triggered for the given sidelink process.

Regarding the switching time for intra-band PC5 CA (see FIG. 6) due to TX switching and interruption time at the receiver it is noted the following: If all the TX carriers are configured and activated simultaneously, then switching between two TX carriers needs no additional time and no interruption at RX. If only part of TX carriers configured and activated simultaneously, e.g., the UE supports a smaller number of TX carriers than RX carriers, then the TX RF LO (local oscillator) needs to be re-tuned to support transmission at other carriers and up to 200 us TX RF retuning time may be needed. Furthermore, the RX chain interruption time can depend on the UE implementation:
Option 1: In case of separate TX/RX chains architecture for each carrier, the RX chain operation may not be interrupted due to TX RF retuning.
Option 2: In case of shared TX/RX chains architecture for carriers, the RX chain operation may be interrupted for up to 200 us.

Regarding the switching time for inter-band PC5 CA (see FIG. 6) due to TX switching and interruption time at the receiver it is noted the following: Since there is only one band specified for PC5 in LTE Rel-15, which is Band 47, inter-band PC5 CA was not available from RAN4 point of view. However, the switching time for inter-band CA depends on UE implementation and can take up to 0 us, 30 us, 100 μs, 200 μs, 300 us, 500 μs, 900 us.

### 1.4 Data Duplication in LTE Rel-15 V2X

Data duplication over PC5 was anchored at PDCP. Duplicated sidelink PDCP PDUs are submitted to two different RLC entities and associated to two different logical channels. Sidelink packet duplication on a single carrier is not supported, i.e., the MAC layer cannot multiplex the two logical channels associated to a duplicate packet into the same HARQ entity.

The eNB configures packet duplication via RRC. The UE shall perform packet duplication for the configured PPPR values until de-configured by eNB reconfiguration. The number of logical channels used for duplication is 10.

### 2. Embodiments

Embodiments described herein can be implemented in addition to SL carrier aggregation of LTE Rel-15.

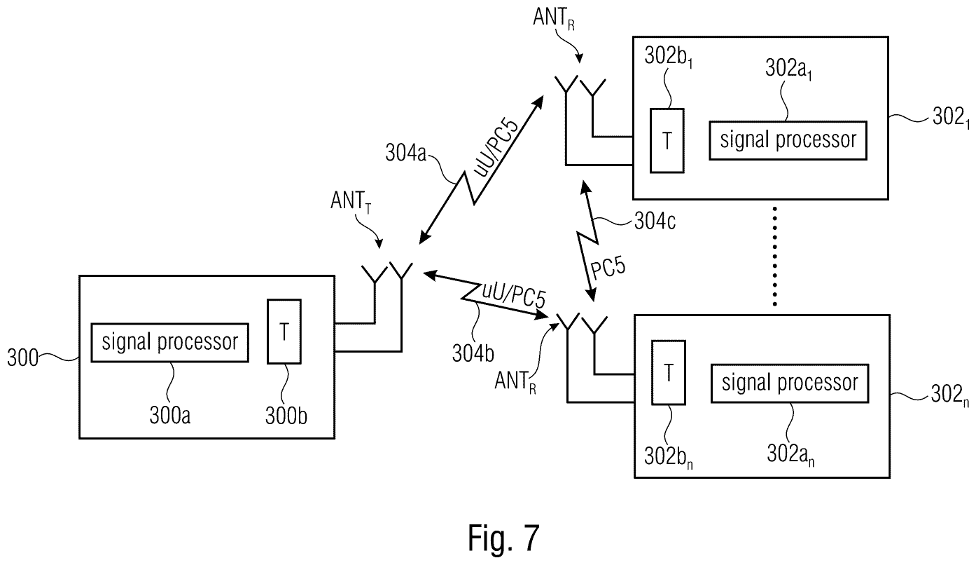

Embodiments of the present invention may be implemented in a wireless communication system as depicted in FIGS. 1-5 including base stations and users, like mobile terminals or IoT devices. FIG. 7 is a schematic representation of a wireless communication system including a central transceiver, like a base station, and one or more transceivers 302₁ to 302ₙ, like user devices, UEs. The central transceiver 300 and the transceivers 302 may communicate via one or more wireless communication links or channels 304a, 304b, 304c, like a radio link. The central transceiver 300 may include one or more antennas ANT_{T} or an antenna array having a plurality of antenna elements, a signal processor 300a and a transceiver unit 300b, coupled with each other. The transceivers 302 include one or more antennas ANT_{R} or an antenna array having a plurality of antennas, a signal processor 302a₁, 302aₙ, and a transceiver unit 302b₁, 302bₙ coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs and the base stations may operate in accordance with the inventive teachings described herein.

Embodiments provide a transceiver of a wireless communication network [e.g., 5G/new radio mobile communication network], wherein the transceiver is configured to transmit and/or receive a signal via a sidelink of the wireless communication network in a [e.g., 5G/new radio] virtual resource pool of the sidelink, the virtual resource pool comprising a plurality [e.g., two or more] of component carriers and/or a two or more resource pools.

For example, a virtual resource pool can be defined with a single component carrier such that it links/joins two or more resource pools within the same component carrier.

In embodiments, the transceiver is configured to transmit and/or receive the signal via the sidelink using carrier aggregation of at least two component carriers of said plurality of component carriers.

In embodiments, each of the two or more resource pools comprises one or more [e.g., two or more] of the plurality of component carriers.

In embodiments, the two or more resource pools are resource pools of one of the following types or a combination of resource pools of at least two of the following types
5G new radio sidelink resource pools,
LTE sidelink resource pools,
WiFi carriers [e.g., based on 802.11p],
a narrowband carrier, e.g., a NB-IoT band,
resource pools of another radio access technology [e.g., D2D radio access technology, e.g., using Bluetooth, or 6G system].

For example, the two or more resource pools don't have to be necessarily of the same type. For instance, the virtual resource pool can include a 5G new radio sidelink resource pool and a LTE sidelink resource pool.

For example, 5G and/or LTE resource pools can be transmit or receive or exceptional resource pools, wherein exceptional resource pools typically are used for handovers (HO).

In embodiments, the virtual resource pool or at least one of two or more resource pools of the virtual resource pool includes two or more bandwidth parts or virtual bandwidth parts, wherein each of the two or more bandwidth parts or virtual bandwidth parts comprises one or more [e.g., two or more] of the plurality of component carriers.

In embodiments, at least a first resource pool of the plurality of resource pools of the virtual resource pool are included in a first bandwidth part, and a second resource pool of the plurality of resource pools of the virtual resource pool are included in a second bandwidth part, wherein each of the first and second bandwidth part are defined with different component carriers.

In embodiments, the transceiver is configured to receive a control information, the control information describing which component carriers of the sidelink from the plurality of component carriers of the virtual resource pool and/or the control information describing which resource pools and/or bandwidth parts and/or virtual bandwidth parts form the virtual resource pool.

In embodiments, the transceiver is configured to use a default component carrier [e.g., of an exceptional resource pool] for transmitting or receiving signals via the sidelink that comprise handover and/or control information and/or feedback and/or broadcast information [such as the PSBCH (physical sidelink broadcast channel) used for transmitting synchronization signals, e.g., S-PSS and S-SSS].

For example, although handover information is usually transmitted via the Uu interface, in embodiments, handover information (or handover related information) can be transmitted via the sidelink, such as in case of a group handover.

In embodiments, the information on the default component carrier is transmitted via one or more of:
physical layer signaling [e.g., 1^{st} and/or 2^{nd} stage SCI via sidelink, or DCI from the gNB via Uu],
RRC or PC5-RRC signaling,
MAC control element,
higher layer signaling.

In embodiments, the default component carrier is a primary cell (PCell).

For example, the aggregate carriers are secondary cells (SCells). SCells have a limited functionality when compared to PCells. SCells do not allow initial access to the gNB, in case of mode 1. Furthermore, SCell functionality could be limited to only support certain features, e.g., no support of a feedback channel, or no support for a certain cast type, etc.

In embodiments, the default component carrier or a configuration update of the default component carrier is configured or preconfigured by one or more of:
the network [e.g., a core network entity such as the mobility management function (AMF) or location management function (LMF)],
a base station [e.g., eNB or gNB],
a roadside unit (RSU),
another UE via sidelink,
stored as a preconfiguration within the UE.

In embodiments, the UE has the capability to signal to the network/BS/another UE, which additional carriers/secondary carriers the UE supports or which carrier combination/vBWP/vRP the UE supports.

In embodiments, the information regarding the default component carrier, along with the additional supported carriers or supported carrier combinations, is signaled from one or more of:
the network,
a base station,
a roadside unit (RSU),
another UE via sidelink.

In embodiments, the transceiver, on receiving the component carrier information, can transmit and/or receive on the given component carriers if it has been configured or pre-configured with the given component carriers [e.g., handshake].

For example, the transceiver can be configured to perform a capability signalling from the transceiver (e.g., UE) to the network/BS/another UE, which additional carriers/secondary carriers the UE supports or which carrier combination/vBWP/vRP the UE supports.

For example, one UE can provide another UE with component carrier information, which the other UE can then use to communicate with.

In embodiments, the transceiver, on not receiving or being aware of the component carrier information, can transmit on the configured or pre-configured component carriers, wherein the transceiver will continue to use the given component carrier dependent on whether it receives a feedback information on the given carrier [e.g. brute force].

For example, instead of the capability signaling, a brute force approach can be used, where the UE will transmit to another UE using the component carriers that it is configured with to another UE, and depending on whether it receives positive/negative feedback, it will continue the transmission.

In embodiments, the feedback information about the given component carrier is one or more of
a HARQ ACK/NACK feedback for a transmission,
a new component carrier based feedback,
any other data received on the PSFCH, e.g., a CI,
any other PHY signal, e.g., control signal sent via 1^{st} or 2^{nd}-stage SCI received or PSBCH signal,
any other RRC, MAC, PC5-RRC, or higher-layer signal received.

In embodiments, the transceiver is configured to receive a linking information [e.g., via the sidelink from another transceiver or from a eNB/gNB or network], the linking information describing which resource pools or bandwidth parts are linked thereby forming a new or further or extended virtual resource pool or a virtual bandwidth part.

For example, “linking” in the sense of a pointer to anther RP or vRP. The idea behind this is that the UE can have some knowledge on this RP/vRP, e.g., information on the carrier freq. etc., so that it can request the gNB/network/another UE to be configured with this RP if the current vRP/RP cannot fulfill a certain criteria. It may not be as strong as a RP within its configured vRP. So a UE may have to ask its base station or another UE, e.g., by sending a request, if it wants to use the linked RP/vRP.

In embodiments, the linking information comprises one or more out of
a control information referencing data in another resource pool and/or virtual resource pool,
a control information referencing control in another resource pool and/or virtual resource pool,
a control information referencing a broadcast signal, e.g., synchronization information, in another resource pool and/or virtual resource pool,
a reservation referencing to another resource pool and/or virtual resource pool,
a feedback information referencing to another resource pool and/or virtual resource pool,
a feedback information combining feedback from two or more resource pools and/or virtual resource pools,
an inter-UE coordination messages (IuC) referencing to another resource pool and/or virtual resource pool,
information indicating a duplicating of data and/or control and/or feedback and/or inter-UE coordination message in another resource pool and/or virtual resource pool.

For example, reservation can be a resource reservation, such as a set of resources which are reserved for this transceiver in the other resource pool or virtual resource pool.

In embodiments, the linking information comprises a switch command, indicating carrier switching between one or more carriers, or virtual resource pool or resource pools or bandwidth parts or virtual bandwidth parts.

For example, the switch command would involve the activation of the new carrier and the deactivation of the old carrier.

In embodiments, the switch command [e.g., explicit trigger] comprises one or more out of
a switching time [e.g., switch in x slots/radio frames/etc.],
an indication to switch from a first resource pool or virtual resource pool to a second resource pool or virtual resource pool or bandwidth part or virtual bandwidth part,
a switching duration [e.g., including when to switch back or when to go into a sleep mode],
a switching timer [e.g., indicating to switch back if a switch back criterion is fulfilled, such as a timeout on target carrier, e.g., nothing received for 1 min on the target carrier],
a switching length and/or periodicity [e.g., indicating the time gap length (MGL =measurement gap length) measured in ms and/or the periodicity (MGRP=measurement gap repetition period)] of when to switch to the linked channel (RP, vRP, BWP, vBWP etc.)],
a switching gap offset, indicating when the linked resource pool or virtual resource pool or bandwidth part or virtual bandwidth part of the linked resource pools or virtual resource pools or bandwidth parts or virtual bandwidth parts becomes valid,
a switching period,
a radio resource control state, that the UE will be in after using the new resource pool or virtual resource pool or bandwidth part or virtual bandwidth part [e.g., RRC_CONNECTED or RRC_INACTIVE or RRC_IDLE].

In embodiments, the switch command is implicit according to one or more of:
a switching threshold [e.g., indicating to switch when a threshold is reached or passed, such as
   too many errors, e.g., HARQ, on carrier,
   signal quality/CBR/interference is above/below a configured threshold,
   minimum required communication range (MRC) is within/exceeded threshold,
   an event [e.g., congestion status of a PCell or default carrier or a congestion status of a subset or all of the secondary carriers].

In embodiments, the transceiver is configured to switch according to the switch command.

In embodiments, the transceiver is configured to switch according to the switch command if a switching condition is fulfilled [e.g., switch if a configured event happens, such as
too many errors, e.g., HARQ, on carrier,
signal quality/CBR/interference is above/below a configured threshold,
minimum required communication range (MRC) is within/exceeded threshold]
a congestion status is above/below a configured threshold.

In embodiments, the transceiver is configured to operate in a 5G new radio sidelink mode [e.g., mode 1 or mode 2] and/or in an LTE sidelink mode [e.g., mode 3 or mode 4].

In embodiments, the at least two component carriers lie in the same or in different frequency ranges [e.g., 5G/new radio frequency ranges 1 and 2] or the carrier frequency is above or below a configured or preconfigured carrier frequency [e.g., all frequencies are required to be below 6 GHz] or aggregated carriers have a minimum required frequency gap in-between.

For example, this can be done to minimize the interference between aggregated carriers.

In embodiments, the transceiver is configured to switch, while using carrier aggregation, from a first component carrier of the at least two component carriers to a second component carrier of the at least two component carriers.

In embodiments, the transceiver is configured to switch from the first component carrier to the second component carrier in dependence on a switching command and/or a switching criterion.

In embodiments, the switch command comprises one or more out of
a switching time [e.g., switch in x slots/radio frames/etc.],
an indication to switch from a first resource pool or virtual resource pool to a second resource pool or virtual resource pool,
a switching duration [e.g., including when to switch back or when to go into a sleep mode],
a switching timer [e.g., indicating to switch back if a switch back criterion is fulfilled, such as a timeout on target carrier, e.g., nothing received for 1 min on the target carrier],
a switching threshold [e.g., indicating to switch when a threshold is reached or passed, such as
   too many errors, e.g., HARQ, on carrier,
   signal quality/CBR/interference is above/below a configured threshold,
   minimum required communication range (MRC) is within/exceeded threshold],
a switching length and/or periodicity [e.g., indicating the time gap length (MGL=measurement gap length) measured in ms and/or the periodicity (MGRP=measurement gap repetition period)] of when to switch to the linked channel (RP, vRP, BWP, vBWP etc.)],
a switching gap offset, indicating when the linked resource pool or virtual resource pool or bandwidth part or virtual bandwidth part of the linked resource pools or virtual resource pools or bandwidth parts or virtual bandwidth parts becomes valid,
a switching period,
a radio resource control state, that the UE will be in after using the new resource pool or virtual resource pool or bandwidth part or virtual bandwidth part [e.g., RRC_CONNECTED or RRC_INACTIVE or RRC_IDLE],
a physical or higher layer signal, [such as a DCI from the base station, or an SCI from an RSU, a GL UE or another UE, or higher layer signaling such as MAC CE or PC5-RRC], indicating to switch from a first resource pool or virtual resource pool to a second resource pool or virtual resource pool.

In embodiments, the switching criterion is at least one out of
priority,
latency,
data rate,
an allowed resource selection type [e.g., sensing, partial sensing or random] in the second component carrier,
an enabled channel [e.g., PSFCH] in the second component carrier,
a number of received ACKS or NACKS,
a cast type enabled in the second component carrier,
a cast type used by other transceivers in the second component carrier,
a number of errors on a component carrier reaches a configured threshold [e.g., HARQ based],
a signal quality [e.g., path loss, is above/below a configured threshold],
a channel busy ratio is above/below a configured threshold.
an interference ratio is above/below a configured threshold,
minimum required communication range (MRC) is within/exceeded threshold
a congestion status of the carrier [e.g., number of UEs operating on the current carrier is above a configured or preconfigured threshold]
a resource allocation type [e.g., the current RP/vRP does not allow to do random resource selection which is typically used for power saving UEs. The current resource pool might only allow sensing/partial sensing/contiguous partial sensing (CPS) based access of resources].

In embodiments, the transceiver has stored a table or RRC information element (IE) listing the at least two component carriers or wherein the transceiver is configured to receive a control information describing the table listing the at least two component carriers, wherein the table lists further information associated with the respective component carrier.

In embodiments, the table is provided by preconfiguration or configuration to the transceiver [e.g., UE, BS, network] or by an inter-UE coordination message by another transceiver [e.g., UE or RSU] [e.g., via the sidelink].

In embodiments, the further information is one or more out of
a switching time of the respective component carrier,
a priority of the respective component carrier,
a latency of the respective component carrier,
a data rate of the respective component carrier,
a reliability information [e.g., interference, path loss, etc.] of the respective component carrier,
an allowed resource selection type [e.g., sensing, partial sensing or random] of the respective component carrier,
whether NR—U based techniques [e.g., COT-sharing [COT=channel occupancy time]], is allowed on the respective carrier,
an enabled channel [e.g., PSFCH] of the respective component carrier,
a cast type enabled or a cast type restriction in the respective component carrier,
a cast type used by other transceivers in the respective component carrier,
inter-UE coordination message is enabled/disabled on the said component carrier,
the type of signaling enabled for inter-UE coordination messages [e.g., RRC-only or RRC/PC-5 RRC and/or SCI-like signaling],
a congestion status of the respective component carrier,
synchronization information [e.g., the relative timing to another component carrier or other synchronization-related information, e.g., a synchronization source or advantageous synchronization source].

In embodiments, the transceiver is configured to perform, while using carrier aggregation,
sensing or partial sensing based resource selection on a selected component carrier of the at least two component carriers,
random resource selection on a selected component carrier of the at least two component carriers.

For example, partial sensing can refer to contiguous partial sensing (CPS) or periodic-based partial sensing (PBPS).

In embodiments, the transceiver is configured to perform sensing or partial sensing based resource selection on two or more of the at least two component carriers in parallel [e.g., simultaneously], in order to obtain a sensing result for each of the two or more component carriers.

In embodiments, the transceiver is configured to select one of the two or more component carriers depending on the respective sensing result.

In embodiments, the transceiver is configured to perform a full-duplex communication using the at least two component carriers.

In embodiments, the at least two component carriers lie in different frequency ranges [e.g., 5G/new radio frequency ranges 1 and 2].

For example, the different frequency ranges can be frequency range 1, FR1, and frequency range 2, FR2, but it can also be two frequency ranges which have a large enough duplex gap, so that interference between both bands is below a certain threshold.

In embodiments, the at least two component carriers lie within different bandwidth parts of different frequency ranges [e.g., 5G/new radio frequency ranges 1 and 2].

In embodiments, the transceiver is configured to select the at least two component carriers out of the plurality of component carriers of the virtual resource pool for carrier aggregation based on a selection criterion.

In embodiments, the transceiver is configured to receive a control information describing the at least two component carriers out of the plurality of component carriers of the virtual resource pool to be used by the transceiver for carrier aggregation, wherein the at least two component carriers are selected out of the plurality of component carriers of the virtual resource pool based on a selection criterion, wherein the transceiver is configured to select the at least two component carriers described by the control information.

In embodiments, the selection criterion is one or more out of
a numerology of a respective bandwidth part or component carrier or of a frequency band in which the respective component carrier lies,
a number of received NACKS of transmissions on a respective component carrier,
configured default component carrier [e.g., for fall back or initial transmission],
the center frequency or the size of the bandwidth of the respective component carrier,
the characteristics of the transmission to be carried out, such as the size of the payload and/or the packet delay budget remaining and/or the priority of the transmission,
the usage of neighboring carriers of the respective component carrier [e.g., in case the neighboring component carriers are heavily used, this might spill over signals, e.g., adjacent channel leakage ratio (ACLR) is above a certain threshold],
the congestion status of the carrier,
a random selection based on a random choice or weighted random choice [e.g., using a uniform distribution].

In embodiments, the transceiver is configured to transmit a first type of information using a first component carrier or virtual resource pool or virtual bandwidth part and to transmit at least a part of a second type of information using a second component carrier or virtual resource pool or virtual bandwidth part.

In embodiments, the first type of information is one out of
control information [e.g., PSCCH],
data [e.g., PSSCH],
feedback information [e.g., PSFCH], broadcast information [e.g., PSBCH, e.g., synchronization],

In embodiments, the second type of information is one out of
control information [e.g., PSCCH],
data [e.g., PSSCH],
feedback information [e.g., PSFCH],
broadcast information [e.g., PSBCH, e.g., synchronization].

In embodiments, the first type of information describes [e.g., points to] the second component carrier or resource pool or bandwidth part within the virtual resource entity.

In embodiments, the transceiver is configured to perform sensing or partial sensing based resource selection on the first component carrier or virtual resource pool or virtual bandwidth part, or wherein the transceiver is configured to perform random resource selection on the first component carrier or virtual resource pool or virtual bandwidth part.

In embodiments, the transceiver is configured to perform sensing or partial sensing based resource selection on the second component carrier or virtual resource pool or virtual bandwidth part, or wherein the transceiver is configured to perform random resource selection on the second component carrier or virtual resource pool or virtual bandwidth part.

In embodiments, the transceiver is configured to perform an initial transmission using a first component carrier or virtual resource pool or virtual bandwidth part and to perform a subsequent transmission using a second component carrier or virtual resource pool or virtual bandwidth part, wherein the initial transmission comprises an information describing [e.g., pointing to] the second component carrier or virtual resource pool or virtual bandwidth part for the subsequent transmission, or wherein the information describing the second component carrier or virtual resource pool or virtual bandwidth part for the subsequent transmission is configured or preconfigured by the network, base station, or another UE.

In embodiments, the time gap between the initial transmission and the subsequent transmission is limited by a configured or preconfigured threshold.

In embodiments, the transceiver is configured to transmit a first type of information using a first component carrier or virtual resource pool or virtual bandwidth part and to transmit at least a part of a second type of information using a second component carrier or virtual resource pool or virtual bandwidth part, wherein the first type of information describes [e.g., points to] the second component carrier or virtual resource pool or virtual bandwidth part.

In embodiments, the transceiver is configured to perform an initial transmission using a first component carrier or virtual resource pool or virtual bandwidth part and to perform a subsequent transmission, following the first transmission, using a second component carrier or virtual resource pool or virtual bandwidth part.

In embodiments, the transceiver is configured to perform a first proper subset of periodic transmissions using a first component carrier or virtual resource pool or virtual bandwidth part and to perform a second proper subset of the periodic transmissions following the first proper subset of periodic transmissions using a second component carrier or virtual resource pool or virtual bandwidth part.

In embodiments, the initial transmission or one of the other transmissions on the first component carrier or virtual resource pool or virtual bandwidth part comprises an information describing [e.g., pointing to] the second component carrier or virtual resource pool or virtual bandwidth part.

In embodiments, the transceiver is configured to perform control and/or data transmissions using a first component carrier or virtual resource pool or virtual bandwidth part and to transmit and/or receive feedback information using a second component carrier or virtual resource pool or virtual bandwidth part.

In embodiments, the transceiver is configured to perform control and/or data transmissions using a first component carrier of resource pool or bandwidth part of a virtual resource entity and to receive feedback information on the same component carrier of resource pool or bandwidth part.

For example, this can ensure backward compatibility, where a Rel-16 UE can transmit/receive only on the first component carrier/RP/BWP, and can hence send the feedback also only in the first one. The possible data transmission could be only partial, or could be duplicated in the second carrier/RP/BWP

In embodiments, the transceiver is configured to perform control transmissions using a first component carrier or virtual resource pool or virtual bandwidth part and to transmit and/or receive data and/or feedback information using a second component carrier or virtual resource pool or virtual bandwidth part.

In embodiments, the transceiver is configured, in case of a successful transmission on one of the at least two component carriers, to stop/terminate a transmission on another one of the at least two component carriers, or wherein the transceiver is configured, in case of an unsuccessful transmission on one of the at least two component carriers, to trigger a transmission or retransmission on another one of the at least two component carriers.

In embodiments, the virtual resource pool includes one or more [e.g. two or more] exceptional resource pools.

In embodiments, the exceptional resource pool(s) have associated therewith different numerologies, wherein the transceiver is configured to use a resource pool having a lower numerology for a normal handover and to use a resource pool having a higher numerology for a faster handover.

Further embodiments provide a transceiver of a wireless communication network [e.g., 5G/new radio mobile communication network], wherein the transceiver is configured to transmit a signal via a sidelink of the wireless communication network using carrier aggregation of at least two component carriers, wherein the transceiver is configured to switch between a first component carrier to a second component carrier.

Further embodiments provide method for transmitting or receiving signals in a wireless communication network [e.g., 5G/new radio mobile communication network], wherein the method comprises a step of transmitting or receiving a signal via a sidelink of the wireless communication network in a [e.g., 5G/new radio] virtual resource pool of the sidelink, the virtual resource pool comprising a plurality [e.g., two or more] of component carriers and/or two or more resource pools.

Further embodiments provide method for transmitting signals in a wireless communication network [e.g., 5G/new radio mobile communication network], wherein the method comprises a step of transmitting a signal via a sidelink of the wireless communication network using carrier aggregation of at least two component carriers, wherein transmitting the signal comprised switching between a first component carrier to a second component carrier.

Embodiments provide a transceiver of a wireless communication network [e.g., 5G/new radio mobile communication network], wherein the transceiver is configured to transmit and/or receive a signal via a sidelink of the wireless communication network in a virtual resource pool of the sidelink, the virtual resource pool comprising at least one out of
two or more component carriers [e.g., 5G/new radio component carriers],
two or more resource pools [e.g., 5G/new radio resource pools], where the resource pools are configured or pre-configured on different component carriers,
two or more bandwidth parts [e.g., 5G/new radio bandwidth parts], where the bandwidth parts are defined configured or pre-configured on different component carriers.

It is to be noted that the term “virtual resource pool” might not be used in the standard, and a different terminology might be used. The “virtual resource pool” or “virtual resource entity” is essentially a group of resources that are assigned, configured or pre-configured together, where the resources belong to different component carriers.

The virtual resource pool could consist of discontiguous resources, where one component carrier/resource pool/BWP is configured with a frequency gap with the other. It can hence be labelled as a R18 resource pool, R18 SL resource pool, or R18 SL CA resource pool.

In embodiments, a first bandwidth part can contain a first resource pool, part of a first component carrier. A second bandwidth part can contain a second resource pool, part of a second component carrier, note, this could also contain a third resource pool, fourth resource pool, exceptional resource pool. Also, it might not be called virtual RP but just carrier aggregation for NR V2X.

In accordance with embodiments, carrier aggregation can be performed in different frequency ranges. Frequency scopes within the NR releases are for reasons of different wave propagation effects divided into two ranges:
Frequency range 1 (FR1): New frequency bands<6 GHz.
Frequency range 2 (FR2): Including new frequency bands 24.25-52.6 GHZ.

FR1 is sometimes also referred to as low band, whereas FR2 is sometimes referred to as high band.

Whereas LTE CA was only standardized for low bands, the new frequency ranges in NR allow to address many new use cases and scenarios. With CA being introduced on the NR SL in accordance with embodiments, new possibilities on how to configure and utilize SL CA in the new frequency ranges in FR1 and FR2 efficiently are provided. Furthermore, CA in NR in accordance with embodiments allows to aggregate carriers in different BWPs, and thus, frequency bands with different numerologies can be aggregated. This has implications on timings and data rates if numerologies differ between the aggregated carriers.

2.1 Virtual Resource Pool, Bandwidth part and Component Carrier Concept

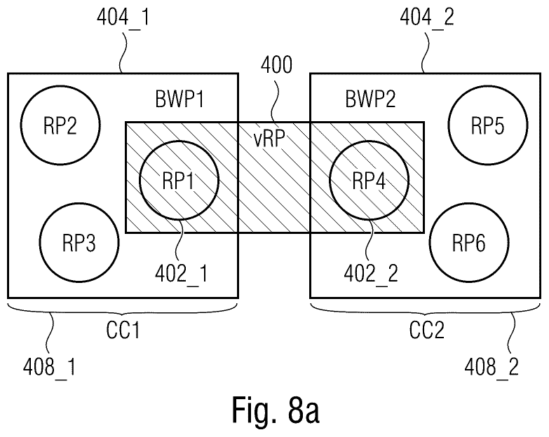

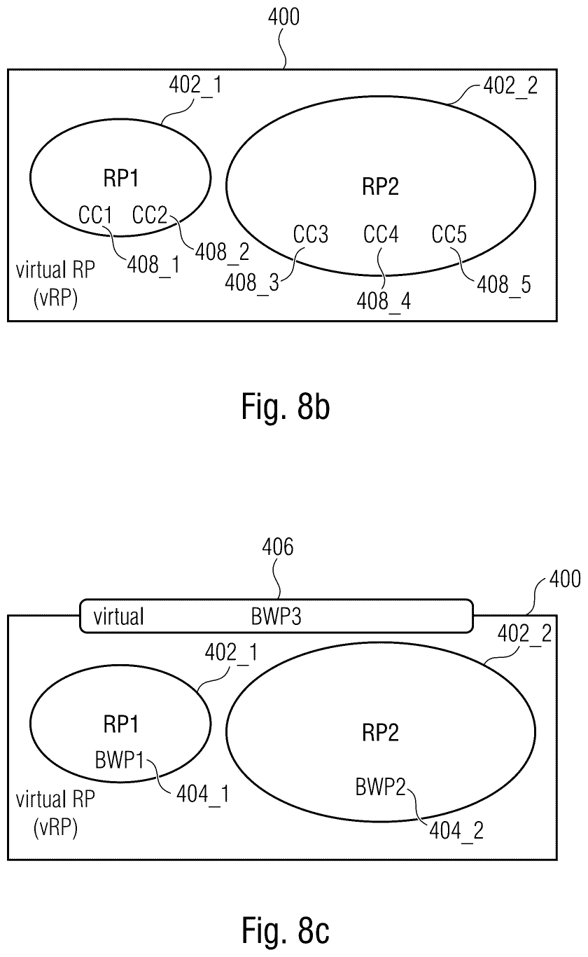

To reduce signaling for configuration of CA for UEs in SL or even without CA to enable joint usage of multiple RPs, in accordance with embodiments, the gNB or a scheduling UE could configure or preconfigure a virtual RP, wherein the virtual RP includes or comprises one or more RPs, and where each RP lies within one or more CCs. This could be unicasted or broadcasted or groupcasted to the involved UEs, which would then know in a compact form, in which CCs each RP is embedded. In embodiments, RPs used for handover traffic, e.g., the exceptional pool, could be configured or preconfigured with a default CC, whereas RPs used as large data pipes could be configured or preconfigured with a maximum number of CCs. Examples are depicted in FIGS. 8a to 8c, which show a forming of a virtual RP (vRP) to reduce signaling to a UE, respectively. Furthermore, a vRP could also include a plurality of exceptional pools, e.g., to support different kind of handovers (HOs). In one example, a HO could be performed quicker if a higher numerology is used within the corresponding exceptional pool. Thus, a V2X-UE could choose the exceptional pool with a basic numerology for a normal HO, and choose the exceptional pool with a higher numerology for optimized or fast HOs. Note that the above described CA concept would allow to support CA with more than 1 BWP, where each BWP is configured with a different numerology and thus each BWP could comprise an exceptional pool having a different numerology.

Given that the Rel 16/17 specifications configure resource pools within a SL BWP, the most straightforward means to achieve CA would be to group or assign two or more different BWPs, or resource pools belonging to each of these BWPs, into a virtual resource entity. The BWPs are defined using different frequency domain locations and bandwidths that pertain to different center frequencies and hence belong to different component carriers. Each of these BWPs would contain one or more resource pools. This is depicted in FIG. 8a.

Specifically, FIG. 8a shows a schematic representation of a virtual resource pool 400 including two or more resource pools, such as a first resource pool 402_1 and a second resource pool 402_2. As shown in FIG. 8a, at least a first resource pool 402_1 of the plurality of resource pools of the virtual resource pool 400 can be included in a first bandwidth part 404_1, and a second resource pool 402_2 of the plurality of resource pools of the virtual resource pool 400 can be included in a second bandwidth part 404_2, wherein the first and second bandwidth parts 404_1 and 404_2 can be defined with different component carriers 408_1 and 408_2, e.g., the first bandwidth part 404_1 can be defined with a first component carrier 408_1 and the second bandwidth part 404_2 can be defined with a second component carrier 408_2. In other words, FIG. 8a shows the case where the virtual resource pool contains multiple BWPs that in turn contain resource pools, where each of these BWPs are defined in different carriers.

FIG. 8b shows a schematic representation of a virtual resource pool 400 including two or more resource pools, such as a first resource pool 402_1 and a second resource pool 402_2. Thereby, each of the two or more resource pools lies within (or comprises) one or more component carriers. For example, the first resource pool 402_1 can lie within (or comprise) two component carriers, such as a first component carrier 408_1 and a second component carrier 408_2, wherein the second resource pool 402_2 can include three component carriers, such as a third component carrier 408_3, a fourth component carrier 408_4 and a fifth component carrier 408_5.

FIG. 8c shows a schematic representation of a virtual resource pool 400 including two or more resource pools, such as a first resource pool 402_1 and a second resource pool 402_2, wherein each of the two or more resource pools can include one or more bandwidth parts. For example, the first resource pool 402_1 can lie within (or comprise) a first bandwidth part 404_1, wherein the second resource pool 402_2 can lie within (or comprise) a second bandwidth part 404_2. In other words, and as also indicated in FIG. 8c, instead of a virtual resource pool 400 also a virtual bandwidth part 406 can be configured, wherein the virtual bandwidth part 406 can include two or more bandwidth parts, such as a first bandwidth part 408_1 and a second bandwidth part 408_2.

In embodiments, cross-RP and cross-vRP scheduling is supported. The main aspect is that RPs can be linked or form a vRP. For example, an SCI could contain in the first or second stage an indicator that indicates the RP in which a resource allocation and/or one or more reservations lie. The benefit of this is that this can be backwards-compatible since legacy UEs can ignore the signaling and still operate in the separate RPs. In a further embodiment, the resource numbering may be continuous over the linked RPs or the vRP. For example, the first resource of the first RP with M resources in frequency may be associated with the lowest index. Then, the first resource of the second RP may be associated with index M. The benefit of this is that no additional indicator field is needed but the FRIV indicates where the resource allocation lies. In another embodiment, resource allocations may be copied among linked RPs or RPs of a vRP. For example, an SCI received in an RP with an associated resource allocation in the same RP may also indicate a further “copied” resource allocation in all or a subset of the other RPs.

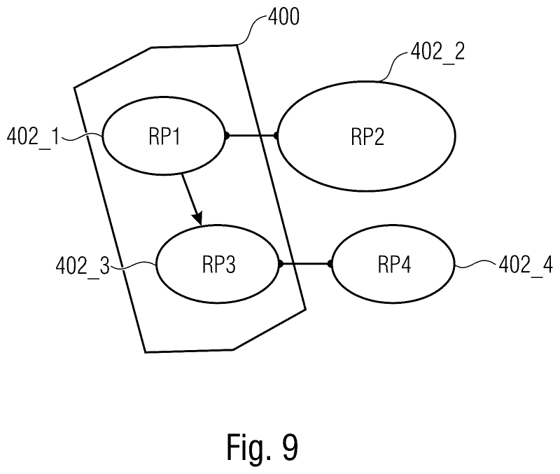

FIG. 9 shows a schematic representation of linked resource pools. Specifically, FIG. 9 shows four resource pools 402_1, 402_2, 402_3 and 404_4, wherein the first resource pool 402_1 is linked to the third resource pool 402_3, the first resource pool 402_1 and the third resource pool 402_3 thereby forming a virtual resource pool 400.

For this, RP-linking can be signaled between gNB and UE in mode 1, or between UEs in mode 2. Furthermore, the signaling can be broadcasted by the gNB, or it can be signaled on the physical layer (PHY), via RRC or PC5-RRC or MAC CE, or via a higher layer protocol or it may be preconfigured to the UE. In case this is signaled on the PHY, this can be signaled via DCI/PDCCH in mode 1, or via 1^{st}-or 2^{nd}-stage SCI if transmitted between UEs. Finally, this information can also be exchanged by a GL-UE via sidelink assistance information message (AIM), which can also be referred to as inter-UE coordination message (IUC).

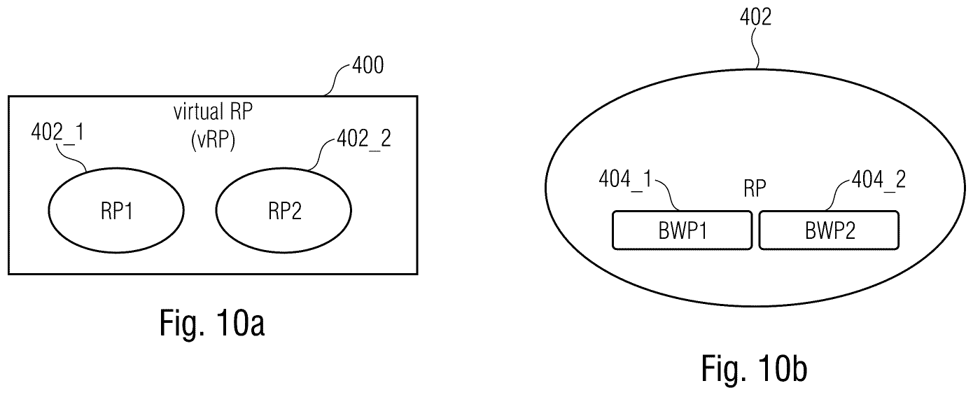

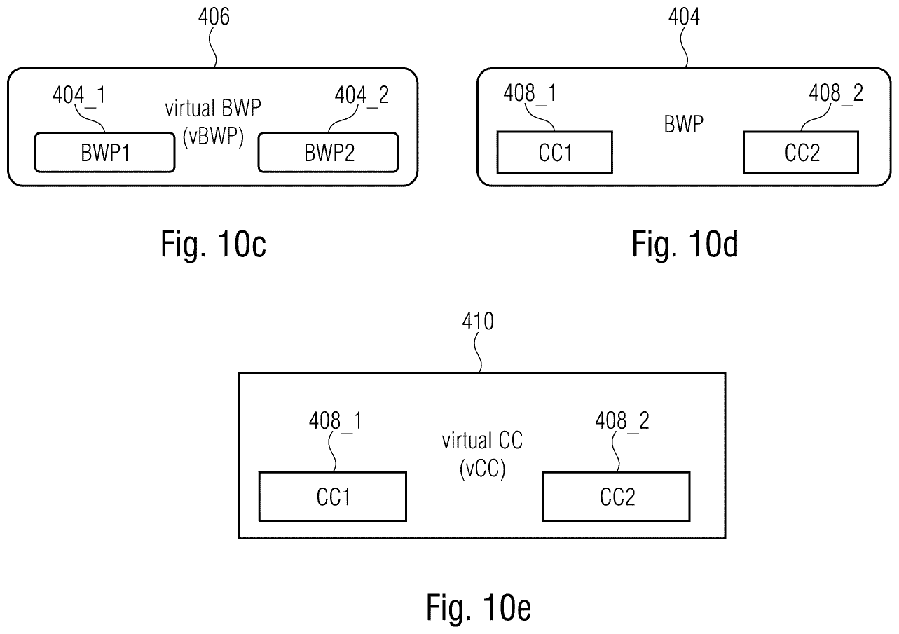

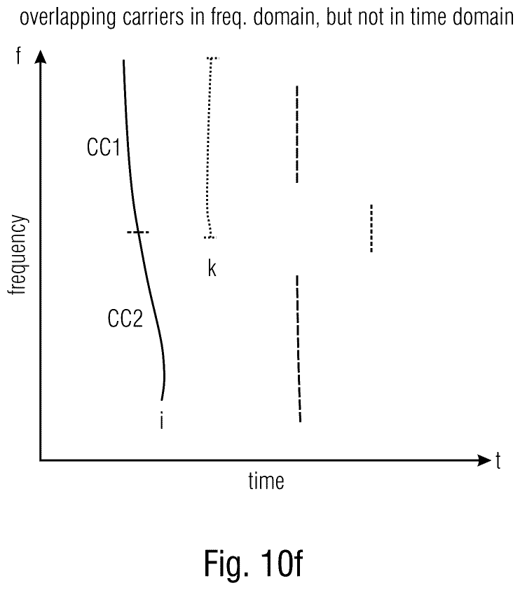

In embodiments, a resource pool (RP) or virtual resource pool (vRP) 400 can be configured to contain not only one or more resource pools 402_1 and 402_2 as shown in FIG. 10a. A resource pool 402 itself (e.g., resource pool 402_1 and/or resource pool 402_2 of FIG. 10a) can lie within (or comprise) one or more bandwidth parts 404_1 and 404_2 as shown in FIG. 10b. A bandwidth part (BWP) can also be a virtual bandwidth part (vBWP) 406 that can be configured to contain one or more bandwidth parts 404_1 and 404_2 as shown in FIG. 10c. A bandwidth part 404 (e.g., bandwidth part 404_1 and/or bandwidth part 404_2 of FIG. 10b or 10c) can lie within (or comprise) one or more component carriers 408_1 and 408_2 as shown in FIG. 10d. A component carrier (CC) can be a virtual component carrier (vCC) 410 that can be configured to contain one or more component carriers 408_1 and 408_2 as shown in FIG. 10e.

In embodiments, these concepts can be combined by configuring one or more:
resource pools (RP) to be virtual resource pools (vRP),
bandwidth parts (BWP) to be virtual bandwidth parts (vBWP),
component carriers (CC) to be virtual component carriers (vCC).

The virtual resource entity would essentially define the following possibilities:
two or more frequency contiguous BWPs, each containing one or more resource pools, each BWP defined over different component carriers,
one frequency discontiguous BWP, consisting of 2 or more resource pools, or sets of RBs, each resource pool or set defined over different component carriers,
one frequency discontiguous resource pool, consisting of 2 or more sets of RBs, each set defined over different component carriers.

The first possibility would reuse the existing information elements defined in the specifications for the BWP and the resource pool. The second possibility of configuring a frequency discontiguous BWP can be defined using the following exemplary information element: Thereby, in the below examples, elements being highlighted in yellow may be provided, modified or changed according to the inventive approach described herein.

SL-BWP-CA information element

```
-- ASN1START
-- TAG-BWP-START
SL-BWP-CA ::= SEQUENCE {
  locationAndBandwidth1 INTEGER (0..37949),
      locationAndBandwidth2 INTEGER (0..37949),
  subcarrierSpacing SubcarrierSpacing,
  cyclicPrefix ENUMERATED { extended } OPTIONAL
-- Need R
}
-- TAG-BWP-STOP
-- ASN1STOP
```

Such a discontiguous BWP would enable it to be defined across different component carriers, that may or may not overlap with each other, while maintaining the same subcarrier spacing and cyclic prefix for the BWP. Within each of these component carriers, one or more resource pools can then be defined using the existing SL-BWP-PoolConfig and SL-ResourcePool information elements.

The third possibility of configuring a frequency discontiguous resource pool can be defined using the following exemplary information element. Thereby, in the below examples, elements being highlighted in yellow may be provided, modified or changed according to the inventive approach described herein.

SL-ResourcePool information element

```
-- ASN1START
-- TAG-SL-RESOURCEPOOL-START
SL-ResourcePool-r16 ::=  SEQUENCE {
  sl-PSCCH-Config-r16  SetupRelease { SL-PSCCH-Config-r16 }
OPTIONAL, -- Need M
  sl-PSSCH-Config-r16  SetupRelease { SL-PSSCH-Config-r16 }
OPTIONAL, -- Need M
  sl-PSFCH-Config-r16  SetupRelease { SL-PSFCH-Config-r16 }
OPTIONAL, -- Need M
  sl-SyncAllowed-r16  SL-SyncAllowed-r16 OPTIONAL,
-- Need M
  dummy  INTEGER (10..160)  OPTIONAL,
-- Need M
      sl-componentCarrierList-r18 SEQUENCE (SIZE  (1..N)) OF SL-
componentCarrier-r18  OPTIONAL, -- Need M
  sl-Additional-MCS-Table-r16  ENUMERATED {qam256, qam64LowSE, qam256-
qam64LowSE }  OPTIONAL, -- Need M
  sl-ThreshS-RSSI-CBR-r16  INTEGER (0..45)  OPTIONAL,
-- Need M
  sl-TimeWindowSizeCBR-r16  ENUMERATED {ms100, slot100}
OPTIONAL, -- Need M
  sl-TimeWindowSizeCR-r16 ENUMERATED {ms1000, slot1000}
OPTIONAL, -- Need M
  sl-PTRS-Config-r16  SL-PTRS-Config-r16  OPTIONAL,
-- Need M
  sl-UE-SelectedConfigRP-r16  SL-UE-SelectedConfigRP-r16
OPTIONAL, -- Need M
  sl-RxParametersNcell-r16  SEQUENCE {
    sl-TDD-Configuration-r16  TDD-UL-DL-ConfigCommon
OPTIONAL, -- Need M
    sl-SyncConfigIndex-r16  INTEGER (0..15)
  }  OPTIONAL, -- Need M
  sl-ZoneConfigMCR-List-r16  SEQUENCE (SIZE (16)) OF SL-ZoneConfigMCR-r16
OPTIONAL, -- Need M
  sl-FilterCoefficient-r16  FilterCoefficient  OPTIONAL,
-- Need M
  sl-RB-Number-r16 INTEGER (10..275)  OPTIONAL,
-- Need M
  sl-PreemptionEnable-r16  ENUMERATED {enabled, pl1, pl2, pl3, pl4, pl5, pl6, pl7,
pl8}  OPTIONAL, -- Need R
  sl-PriorityThreshold-UL-URLLC-r16 INTEGER (1..9)  OPTIONAL,
-- Need M
  sl-PriorityThreshold-r16  INTEGER (1..9) OPTIONAL,
-- Need M
  sl-X-Overhead-r16  ENUMERATED {n0,n3, n6, n9}  OPTIONAL,
-- Need S
  sl-PowerControl-r16  SL-PowerControl-r16  OPTIONAL,
-- Need M
  sl-TxPercentageList-r16  SL-TxPercentageList-r16  OPTIONAL,
-- Need M
  sl-MinMaxMCS-List-r16  SL-MinMaxMCS-List-r16  OPTIONAL,
-- Need M
  ...,
  [[
  sl-TimeResource-r16  BIT STRING (SIZE (10..160)) OPTIONAL
-- Need M
  ]]
}
SL-componentCarrier-r18 ::=  SEQUENCE {
      sl-SubchannelSize-r16  ENUMERATED {n10, n12, n20, n25, n50, n78,
n100}  OPTIONAL, -- Need M
  sl-StartRB-Cubchannel-r16 INTEGER (0.265) OPTIONAL,
-- Need M
  sl-NumSubchannel-r16  INTEGER (1..27) OPTIONAL,
}
```

The exemplary resource pool definition can define up to N different set of RBs pertaining to different component carriers. This is done by varying the starting RB of each of these sets of RBs, the sub channel size and the number of sub channels.

In embodiments, RPs or CCs can be organized within a cell concept, like the CA concept in Uu. This can be achieved by marking RPs (or CCs or BWPs) as primary and secondary cells or primary and secondary RPs. Typically, there exists only one primary RP, and one or more secondary RPs. The primary RP is used for setting up CA and carries all needed control traffic, e.g., which may also include synchronization via S-PSS and S-SSS. Furthermore, it can also be a fallback solution, in case a secondary carrier suddenly becomes unavailable. In addition, the primary RP does not have to be limited to transmit control traffic but can also transmit data or broadcast information as well as feedback information, e.g., HARQ traffic or measurement data, e.g., CSI feedback or the collision indicator (CI) used in IUC.

There can be two means of UEs understanding each other's supported primary and possible secondary RPs—the handshake method and the brute force method.

Handshake: Carries can overlap in freq. domain, but should also be backwards compatible with legacy UEs. There should be some kind of capability signaling using a default/primary band, in order to decide which carriers are used for control/data/feedback/synchronization.

Brute force: Furthermore, we could have indirect signaling, e.g., in Mode 2, that a UE uses a certain CA combination, if no feedback is received, it indirectly may decide that the other UE does not support this carrier.

FIG. 10f shows a schematic representation of carriers that overlap in the frequency domain but not in the time domain.

### 2.2 Sidelink Carrier Selection-Duplexing

### 2.2.1 Half Duplex for Intra-band CA: Contiguous, Non-Contiguous Carriers

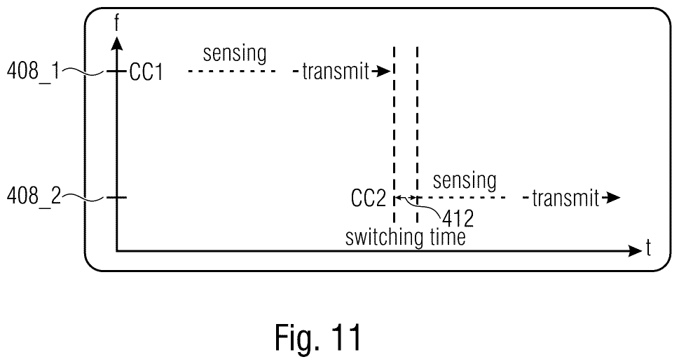

The simplest form of CA is to perform carrier switching over a certain time period or periodically. Depending on the used carrier frequencies/ranges, a UE can transmit on a first component carrier 408_1, e.g., CC1, and switch after a successful or unsuccessful transmission to a different component carrier 408_2, e.g., CC2, where it can transmit new data or continue its transmission, as shown in FIG. 11. Thereby, in FIG. 11 the ordinate denotes the frequency and the abscissa the time. Depending on the frequency ranges involved, this might involve a band switching time 412, which can be used for retuning the RF. First and second component carriers 408_1 and 408_2 can be within the same frequency range or within different frequency ranges, e.g., first component carrier 408_1 (CC1) in FR1 and second component carrier 408_2 (CC2) in FR2. For sidelink operation, this can involve performing additional sensing on the aggregated carrier, e.g., here on the second component carrier 408_2 (CC2).

In embodiments, a table of switchable CCs or frequency bands and/or switching times can be stored within the UE, e.g., using preconfiguration, or signaled to the UE. This can be signaled, for example, from a gNB or via inter-UE coordination (IUC) message from another UE, e.g., from a coordinating UE. Furthermore, the gNB or UE can signal to the said UE, on which band or CC to perform carrier sensing, or set a list of priority sensing bands. By this, the UE can fall back to an agreed CC for sensing after a transmission is performed, or after a NACK/ACK is received, e.g., in case the transmission is part of a PSFCH-enabled transmission.

If signaled via gNB, this can be part of the resource pool or vRP or bandwidth part or vBWP configuration transmitted or broadcasted via SIB. If part of an IUC message, this can be signaled via SCI, e.g., 1^{st} and/or 2^{nd} stage SCI, via MAC-CE, via RRC, or via higher layer message. Furthermore, this could also be stored within the core network (CN), and provided by one of the network functions, e.g., by the access & mobility management function (AMF) or any other network function (NF) of the 5G core (5GC).

In embodiments, the CC switch can have a priority, latency and or data rate tag attached, such that the UE could chose a particular CA mode, e.g., inter-band or intra-band, according to its traffic requirements, e.g., packet delay budget (PDB) or data rate requirement or priority of the data or control or feedback traffic. Furthermore, within the table, the bands can be ranked or sorted based on a criterion, e.g., interference measured in a band/BWP/RP or frequency propagation/pathloss of wave propagation within a particular frequency band. The ranking described above can also be based on the configuration of a given RP on a CC involving one or more of:
Partial-sensing is allowed in the particular RP/CC;
PSFCH-enabled in a given RP/CC;
Number of ACKs/NACKs, received in a given RP, e.g., if a UE received a number of NACKs in a PSFCH-enabled RP on a particular CC it might decrease the priority for a given CC, for potential future transmissions. The reason for this is that it can link the NACK probability to an interference-polluted RP or to worse propagation effects of a particular frequency range of a particular CC;
Cast-type enabled in a given RP/CC;
Cast-type used by other UEs in a given RP/CC, e.g., UE favors to operate for certain messages in a pool where groupcast or broadcast is heavily used, since other UEs might expect groupcast pr broadcasted messaged in the given pool;
Random resource selection allowed in the particular RP;
Numerology configured for a particular BWP/CC used by the RP.

Note that different flavors of partial sensing may be allowed, such as periodic based partial sensing (PBPS), where sensing is performed with a certain period and non-sensing gaps in-between, or contiguous partial sensing (CPS), where sensing is only performed in certain time—and/or frequency positions. Typically, this is performed by power saving UEs, e.g., P-UEs, to reduce battery usage since the UE can save battery in the non-sensing gaps. Obviously, performing no sensing as in random reselection may be the advantageous way of channel access for P-UEs, but which might cause interference to other users of the same channel, RP, vRP, BWP, vBWP, CC or vCC.

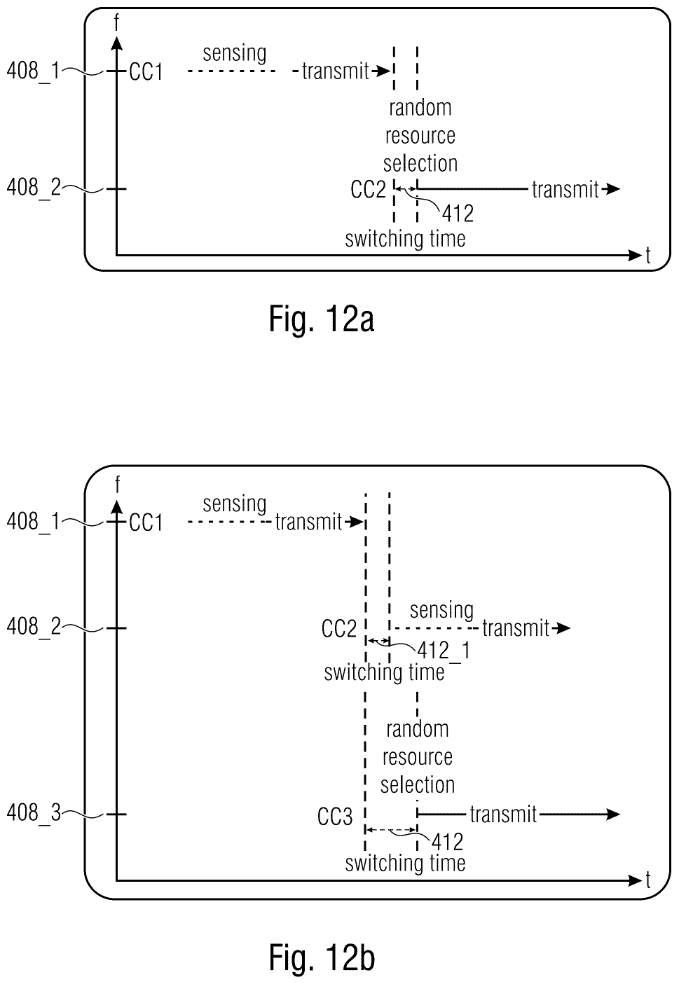

Examples of a component carrier switching are depicted in FIGS. 12a and 12b. Specifically, FIGS. 12a and 12b show schematic representations of exemplary component carrier switching performed by a UE in dependence on a switching criterion. Thereby in FIGS. 12a and 12b the ordinates denote the frequency and the abscissas the time. As indicated in FIG. 12a, the UE might switch under consideration of a switching time 412 from a first component carrier 408_1 for which a sensing-based resource selection is configured to a second component carrier 408_2 for which a random resource selection is configured. In FIG. 12b, the UE might switch from under consideration of respective switching times 412_1 and 412_2 from a first component carrier 408_1 for which a sensing-based resource selection is configured to a second component carrier 408_2 for which a sensing-based resource selection is configured or to a third component carrier 408_3 for which a random resource selection is configured. In other words, FIG. 12a shows that a UE chooses a CC/RP, where it does not have to perform sensing, wherein FIG. 12b shows that a UE chooses a CC/RP based on several criteria, e.g., it switches to the third component carrier 408_3 based on the switching time and CC/RP configuration. Although the switching time might be larger, as compared to switching to the second component carrier 408_2, the channel access time could be smaller, since the UE does not have to perform sensing on the third component carrier and can thus transmit data quicker on the given carrier.

Note that a UE might choose not to switch to a certain CC if the switching time is above a (pre-) configured threshold. This might be the case if the QoS of the data or control or feedback or synchronization data is time-critical, and thus could not be transmitted in time after switching to another CC. For data traffic, this can be the case if the packet delay budget (PDB) cannot be fulfilled after switching to another CC. In this case, CC switching should not be performed.

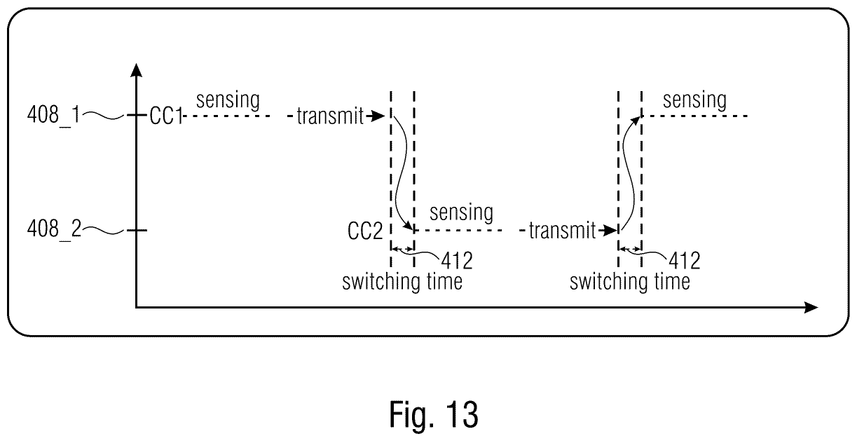

Furthermore, a given RP or a UE can be configured with a default behavior, such that a UE operates on an initial CC, e.g., CC1, which it also uses as a fallback CC when finishing a transmission on a different CC, e.g., CC2, as depicted in FIG. 13. Thereby, FIG. 13 shows a schematic representation of a component carrier switching performed by a UE under consideration of respective switching times 412 with a fallback to a specific component carrier when a fallback criterion is fulfilled, such as after finishing a transmission. In other words, in FIG. 13 a UE switches between different CCs with fallback to a particular CC, such as the first component carrier 408_1.

In embodiments, the UE can be configured to switch with a given time offset to another carrier. If the UE does not have an urgent need to transmit or receive data, this would allow to save power, which might be especially relevant for P-UEs. Furthermore, this could reduce interference, since the given UE does not immediately transmit in the carrier that it switches to.

In embodiments, the UE can be configured to switch with a given periodicity and gap length to one or more carriers. In this example, the given UE could use this kind of mode to scan for control or data or feedback or broadcast information in another carrier, and then switch automatically back to a primary component carrier. This could be beneficial if the UE needs measurement data, e.g., sensing or feedback data, to be received on the other CC, in order to decide whether switching to a given CC would support the traffic requirements of the said UE.

In addition, when switching carriers, the UE could change its current RRC state to an RRC state, to transfer into RRC_IDLE, RRC_INACTIVE, or RRC_CONNECTED, depending on the configuration or preconfiguration of a vRP or vBWP or vCC. In this way, the UE could perform power saving, in case it is only interested in certain messages transmitted on the new carrier that it switched to.

In embodiments, if the UE has several possible candidates of CCs, it could switch randomly to one or more of the CCs, e.g., based on a random choice or random weighted choice. This can be beneficial to reduce the congestion on a future carrier that the UE switches to. This also can be applied for a multi-band transmitter and/or receiver as described below. For example, a multi-band transmitter, e.g., UE, could select two out of five CCs that is can possible transmit on based on a random choice or random weighted choice. Note that also certain priority could be given to lower carriers providing better signal penetration, or higher carriers, which cause less interference to neighboring cells. This could be reflected in a weighting factor.

### 2.2.2 Multiband-Receiver, Single Transmitter

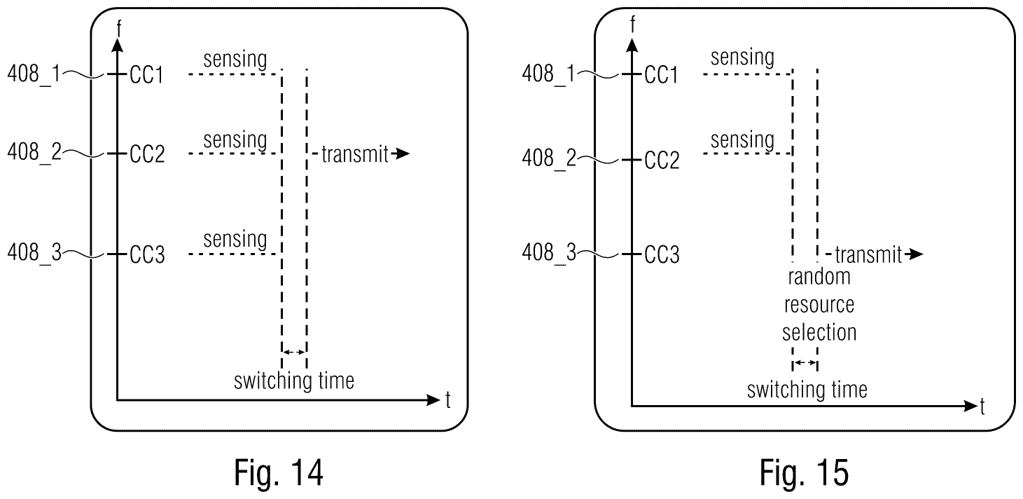

In embodiments, the UE can be configured with multiple receivers, which allow to perform sensing on more than one component carrier simultaneously. Furthermore, the same UE can be configured with a different number of transmitters, e.g., only one transmitter. An example is depicted in FIG. 14 for a UE with multi-receiver and single transmitter capabilities.

Specifically, FIG. 14 shows a schematic representation of a simultaneous sensing on three component carriers 408_1, 408_2 and 408_3 and a transmission on one of the three component carriers 408_1, 408_2 and 408_3 in dependence on the sensing results and/or in dependence on a component carrier selection criterion. In other words, the UE could perform sensing simultaneously and select a given carrier based on the criteria defined in the previous section. Thus, the UE could optimize its transmissions according to its traffic requirements.

In embodiments, the UE could be configured with a fallback carrier which allows random resource selection, or partial sensing or periodic based partial sensing, which can be used for fast access if there are ongoing transmissions or there is too much interference on other CCs, as depicted in FIG. 15 for a UE with multi-receiver and single transmitter capabilities. In detail, FIG. 15 shows a schematic representation of a simultaneous sensing on two component carriers 408_1 and 408_2 and a transmission on a third component carrier 408_3 for which random resource selection is configured. Thereby, the ordinate denotes the frequency and the abscissa the time.

### 2.2.3 Full Duplex for Inter-band CA

For inter-band CA of at least one carrier in FR1 and at least one carrier in FR2. Both frequency bands have different constraints, wrt. analog requirements. Thus, UEs supporting this feature will have separate RF chains in their NR modem for FR1 and FR2. Furthermore, it is expected that these frequency bands can be decoupled wrt.

their analog performance, such that analog impairments between both bands such as out-of-band emission, e.g., measured as adjacent channel leakage ratio (ACLR) or spurious emission from one band to another is not decreasing performance in either frequency range.

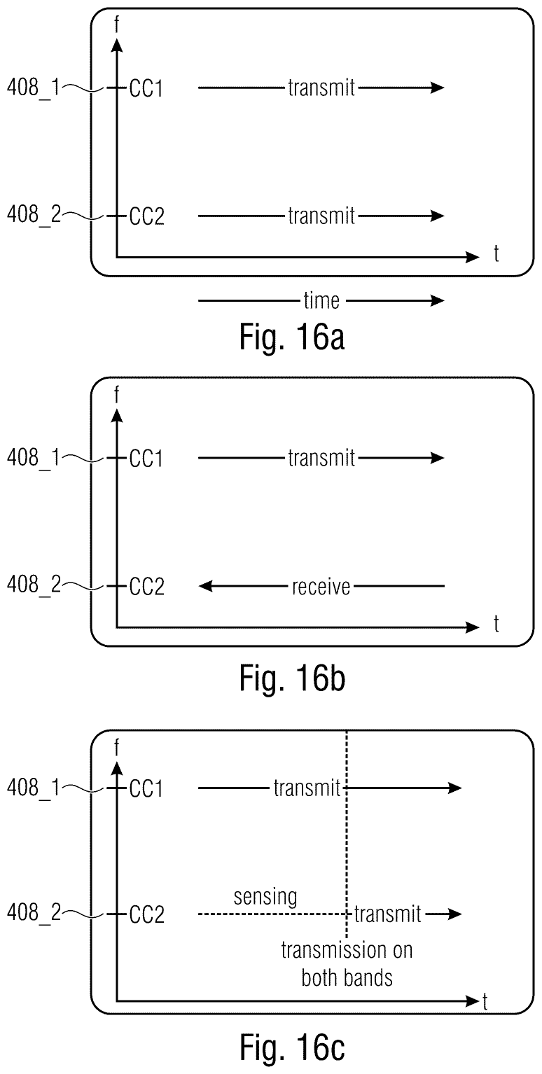

Therefore, this allows simultaneous transmission and/or reception in both frequency ranges. Furthermore, a UE with 2 active antenna branches per frequency range can handle sidelink procedures differently, depending on the frequency range, e.g., transmit in FR1 while performing sensing in FR2 prior to a transmission, as shown in FIGS. 16a-c.

FIG. 16a shows a schematic representation of an inter-band carrier aggregation with simultaneous transmission on two component carriers 408_1 and 408_2 in frequency regions FR1 and FR2. FIG. 16b shows a schematic representation of an inter-band carrier aggregation with simultaneous transmission and reception on two component carriers 408_1 and 408_2 in frequency regions FR1 and FR2. FIG. 16c shows a schematic representation of an inter-band carrier aggregation with simultaneous transmission and sensing on two component carriers 408_1 and 408_2 in frequency regions FR1 and FR2. Thereby, in FIGS. 16a-16c the ordinates denote the frequency and the abscissas the time.

In embodiments, this configuration could be symmetric or asymmetric. In the latter case, sidelink could support a kind of supplemental sidelink (SSL), which can be used to boost capacity on the NR SL for a transmission of one UE to another UE tremendously. If this transmit boost is used, the ongoing transmission in a different frequency band can be halted or reduce to only transmit one or more of control data, feedback data, inter-UE coordination messages (IUC), user data.

### 2.2.4 Sidelink Bandwidth Part Configurations

Another aspect for inter-band CA to work is for multiple active SL BWPs configured for the UE. In this case, the information element, IE, SL-BWP-Config can be capable of providing more than one BWP configuration to the UE. Within each of the BWPs, the resource pools can be defined, as per Rel-16.

For the intra-band CA described above in Section 2.1.1, multiple supporting BWPs can be defined within the same band. In the case of inter-band CA, the BWPs can be defined within different bands. Each of the BWPs can be configured with a different numerology, resulting in a different subcarrier spacing, SCS, or the same SCS. This would result in different timings, which could shorten then sensing times or duration of transmission in bands with a higher numerology. Within each of the BWPs, multiple TX, RX and exceptional resource pools can be defined.

This will provide UEs with the capability to carry out sensing in resource pools in different active BWPs so that UEs can transmit data without having to wait for sensing to be complete in all of the BWPs, if already completed in one of the BWPs which fulfills the transmit requirements. The UE could also perform a kind of pre-sensing before the packet arrives in the buffer, so that it can transmit faster once a data packet arrives.

In the case that multiple active BWPs are not enabled, if a UE intends to receive on the new BWP in a different band, it can do so after considering the switching time. However, if it intends to transmit in the new BWP, it will have to perform either of the following actions:
Carry out random resource selection in the resource pool within the new BWP,” Use the exceptional pool by carrying out random resource selection,
Request for an AIM from another UE that was already using the new BWP/resource pool,
Wait until it has finished adequate sensing, e.g., full-sensing or partial sensing or periodic-based partial sensing, in order to determine the resources for transmission of the intended packet.

The only way to overcome this would be a pre-configuration of the said UE, which could be configured with resource allocation information prior to BWP switching via its “old” BWP. This could be done via another BS or UE that has already access in both BWPs.

The action taken by the UE can be based on the resource pools defined in the BWP, since there are already different resource pools for Mode 1, Mode 2 and exceptional pools.

### 2.3 Conditions for Switching of Component Carriers

Subsequently, conditions that a node (gNB or UE) can consider for the selection of a particular pair (or more) of component carriers for CA are listed:
Consider the bands to switch to depending on the numerology, e.g., SCS, configured for this band.
   Use higher SCS bands for low latency and high priority transmissions, and vice versa for low priority transmissions. The gNB/TX UE can consider the priority, latency and PDB of the transmission before selecting a relevant carrier.
If the UE receives multiple NACKs for a given transmit block (TB), the gNB in Mode 1 on receiving the HARQ reports, can choose to change the carrier and provide the UE with an updated carrier configurations. The same can be done in Mode 2 by the TX UE.
   This can be triggered once the number of NACKs reach a pre-defined threshold.
Check if UEs have a default carrier to fall back on or use for initial transmissions.

In embodiments, some conditions can be applied where the UE does not switch bands too often in order to avoid other UEs not being aware of which band is currently being used. Also, regular switching can also cause significant overhead due to the signaling needed for each of the corresponding transmissions. To reduce signaling overhead, a periodic-based switching could be configured.

### 2.4 U-plane/C-plane Splitting

In embodiments, a UE performing carrier aggregation on the sidelink can be configured to split data and control and/or feedback and/or broadcast information, and send the configuration using one CC, and send data or feedback or broadcast information via another CC. This could also reduce sensing on one of the involved CCs, in case channel access is controlled via the CC transporting control data. The following options could be configured:
U-plane C-plane splitting across carriers, e.g., control plane on CC1 running on FR1, user plane on CC2, e.g., running within FR2.
Consider the switching conditions when a UE decides to continue its periodic transmissions in another band.
Cross-carrier configuration: perform sensing just on main carrier, allocate resources on other carrier using the first carrier, explicit and implicit resource allocation/reservation.

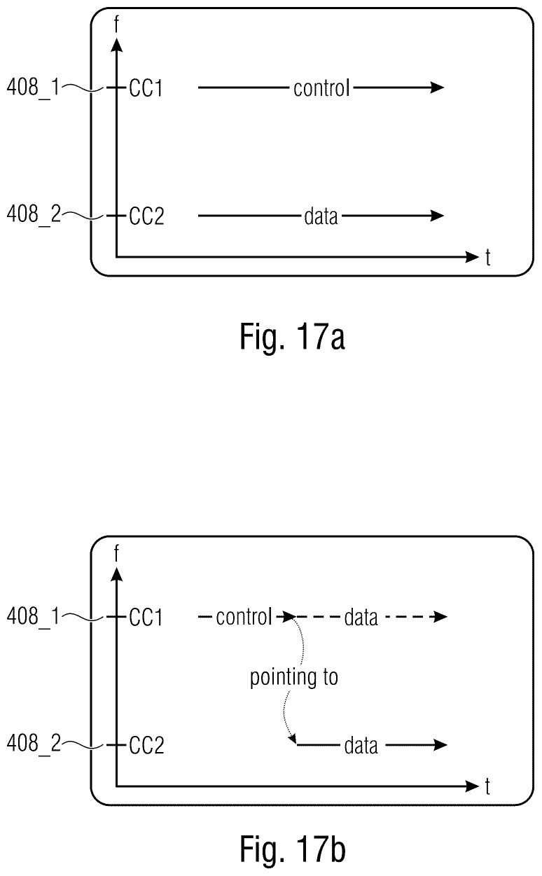

FIG. 17a shows a schematic representation of carrier aggregation of first and second component carriers 408_1 and 408_2, wherein the first component carrier 408_1 is used for a transmission of control information, and wherein the second component carrier 408_2 is used for a transmission of data. FIG. 17b shows a schematic representation of carrier aggregation of first and second component carriers 408_1 and 408_2, wherein the first component carrier 408_1 is used for a transmission of control information and optionally of data, wherein the first component carrier 408_1 points to the second component carrier 408_2 which is used for a transmission of data. Thereby, in FIGS. 17a and 17b the ordinates denote the frequency and the abscissa the time.

2.5 How a UE uses CA

In the above scenario, the UE can choose to transmit a transmit block (TB) in any one of the following methods:
Initial transmission in CC1 with resource allocation information, e.g., containing the time or frequency resource index vector (TRIV/FRIV), in the 1^{st} stage SCI pointing to subsequent transmissions in CC2.
   transmission+retransmissions of initial transmissions in CC1 and remaining periodic transmissions in CC2.
Only control in CC1 with or without dummy data pointing to the actual data in CC2.
Initial transmissions+a few more periodic transmissions in CC1 and the remaining periodic transmissions in CC2.
All control and data transmissions in CC1 and feedback channel on CC2.
   on different carriers, e.g., fast feedback/CSI on high band.
Data duplication or redundancy transmission: the UE transmits a redundant version or an exact copy over more than one CC.

Note that control information could also comprise synchronization information, e.g., S-PSS and/or S-SSS.

### 2.6 CA Behavior/Procedural Embodiments

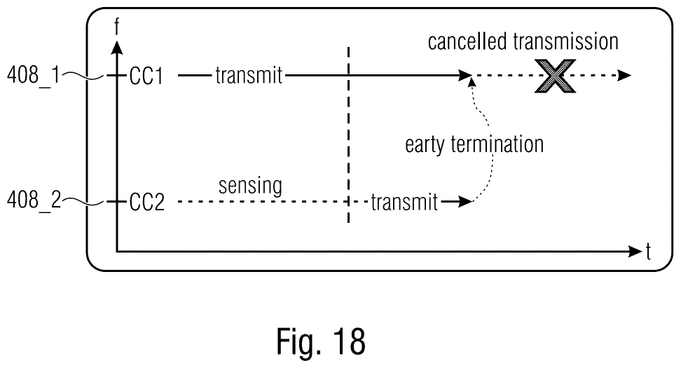

Since transmission on an aggregated carrier is not guaranteed, due to busy status of the media, a UE which has finished transmitting data on an aggregated carrier, such as on a second component carrier 408_2 (CC2), could perform early termination of an ongoing transmission on a different carrier, such as on a first component carrier 408_1 (CC1), and release resources, which have been reserved on one of the carriers, as indicated in FIG. 18. This could be the case if the aggregated carrier is configured with a higher numerology, and thus allows for a faster transmission.

In detail, FIG. 18 shows a schematic representation of a carrier aggregation of first and second component carriers 408_1 and 408_2, wherein an ongoing transmission on the first component carrier 408_1 is terminated after completion of a transmission of data on the second component carrier 408_2. Thereby, the ordinate denotes the frequency and the abscissa the time.

This allows to further optimize resource allocations and reduce interference to other UEs. If CA is performed across different frequency ranges, e.g., CC1 and CC2, since CC2 might allow a much higher throughput, transmission on CC2 is like a data boost, which can free-up a high number of resources on a frequency band used in CC1.

### 2.7 Further Embodiments

Embodiments described herein can be applied to sidelink communication systems, e.g., V2X, as in the context of cellular (e.g., 3G, 4G, 5G, 6G or future), public safety communication systems, campus networks or ad-hoc communication networks.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

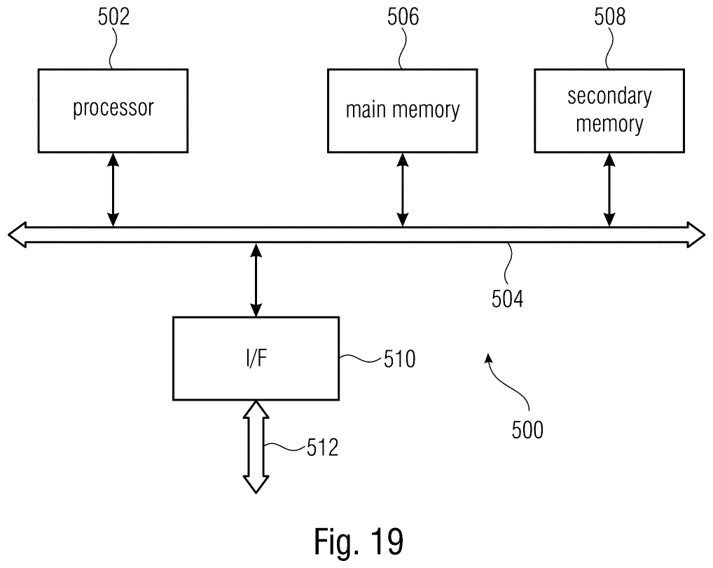

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 19 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510.

The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### ABBREVIATIONS

3GPP third generation partnership project
AAIM aircraft autonomous integrity monitoring
AIM assistance information message
AL alert limit
AMF access and mobility management function
ARAIM advanced receiver autonomous integrity monitoring
BS base station
BWP bandwidth part
CA carrier aggregation
CC component carrier
CBG code block group
D2D device-to-device
DAI downlink assignment index
DCI downlink control information
DL downlink
FFT fast Fourier transform
GMLC gateway mobile location center
gNB evolved node B (NR base station)/next generation node B base station
GNSS global navigation satellite system
HAL horizontal alert limit
HARQ hybrid automatic repeat request
IoT internet of things
LCS location services
LMF location management function
LPP LTE positioning protocol
LTE long term evolution
MAC medium access control
MCR minimum communication range
MCS modulation and coding scheme
MIB master information block
MO-LR mobile originated location request
MT-LR mobile terminated location request
NB node B
NI-LR network induced location request
NR new radio, 5G
NRPPa NR positioning protocol-annex
NTN non-terrestrial network
NW network
OFDM orthogonal frequency-division multiplexing
OFDMA orthogonal frequency-division multiple access
PBCH physical broadcast channel
PC5 sidelink interface
PDCCH physical downlink control channel
PDSCH physical downlink shared channel
PL protection level
PLMN public land mobile network
PPP point-to-point protocol
PPP precise point positioning
PRACH physical random access channel
physical resource block PRB
PRS public regulated services (Galileo)
PSCCH physical sidelink control channel
PSSCH physical sidelink shared channel
PUCCH physical uplink control channel
PUSCH physical uplink shared channel
PVT position and/or velocity and/or time
PVT position, velocity and time
RAIM receiver autonomous integrity monitoring
RAN radio access networks
RAT radio access technology
RB resource block
RNTI radio network temporary identifier
RP resource pool
RRC radio resource control
RS reference symbols/signal
RTK real time kinematics
RTT round trip time
SBAS space-based augmentation systems
SBI service based interface
SCI sidelink control information
SI system information
SIB system information block
SL sidelink
SSR state space representation
TDD time division duplex
TDOA time difference of arrival
TIR target integrity risk
TRP transmission reception point
TTA time-to-alert
TTI transmission time interval
UAV unmanned aerial vehicle
UCI uplink control information
UE user equipment
UL uplink
UMTS universal mobile telecommunication system
V2V vehicle-to-vehicle
V2X vehicle-to-everything
VAL vertical alert limit
VRB virtual resource block
WLAN wireless local area network

### REFERENCES

5 [1] TS 38.306 V16.5.0 (2021-09), 5G;NR; User Equipment (UE) radio access capabilities

1. A transceiver of a wireless communication network,
wherein the transceiver is configured to transmit and/or receive a signal via a sidelink of the wireless communication network in a virtual resource pool of the sidelink, the virtual resource pool comprising a plurality of component carriers and/or a two or more resource pools,
wherein the transceiver is configured to transmit a first type of information using a first component carrier or virtual resource pool or virtual bandwidth part and to simultaneously transmit or receive at least a part of a second type of information using a second component carrier or virtual resource pool or virtual bandwidth part,
wherein the first type of information is feedback information,
wherein the second type of information is feedback information.

2. The transceiver according to claim 1,
wherein the first type of information is transmitted on PSFCH,
wherein the second type of information is transmitted on PSFCH.

3. The transceiver according to claim 1,
wherein the transceiver is configured to transmit and/or receive the signal via the sidelink using carrier aggregation of at least two component carriers of said plurality of component carriers.

4. The transceiver according to claim 1,
wherein each of the two or more resource pools comprises one or more of the plurality of component carriers.

5. The transceiver according to claim 1,
wherein the two or more resource pools are resource pools of one of the following types or a combination of resource pools of at least two of the following types
5G new radio sidelink resource pools,
LTE sidelink resource pools,
WiFi carriers,
a narrowband carrier,
resource pools of another radio access technology.

6. The transceiver according to claim 1,
wherein the transceiver is configured to receive a control information, the control information describing which component carriers of the sidelink from the plurality of component carriers of the virtual resource pool and/or the control information describing which resource pools and/or bandwidth parts and/or virtual bandwidth parts form the virtual resource pool.

7. The transceiver according to claim 1,
wherein the transceiver is configured to use a default component carrier for transmitting or receiving signals via the sidelink that comprise handover and/or control information and/or feedback and/or broadcast information.

8. The transceiver according to claim 1,
wherein the information regarding the default component carrier, along with the additional supported carriers or supported carrier combinations, is signaled from one or more of:
the network,
a base station,
a roadside unit,
another UE via sidelink.

9. The transceiver according to claim 1,
wherein the feedback information about the given component carrier is one or more of
a HARQ ACK/NACK feedback for a transmission,
a new component carrier based feedback,
any other data received on the PSFCH.

10. The transceiver according to claim 1,
wherein the transceiver is configured to operate in a 5G new radio sidelink mode and/or in an LTE sidelink mode.

11. The transceiver according to claim 1,
wherein the at least two component carriers lie in the same or in different frequency ranges or the carrier frequency is above or below a configured or preconfigured carrier frequency or aggregated carriers comprise an offset in frequency domain in-between the carriers.

12. The transceiver according to claim 1,
wherein the transceiver is configured to perform, while using carrier aggregation, one or more of
sensing or partial sensing based resource selection on a selected component carrier of the at least two component carriers,
random resource selection on a selected component carrier of the at least two component carriers.

13. The transceiver according to claim 1,
wherein the at least two component carriers lie within different bandwidth parts of different frequency ranges.

14. The transceiver according to claim 1,
wherein the transceiver is configured to select the at least two component carriers out of the plurality of component carriers of the virtual resource pool for carrier aggregation based on a selection criterion.

15. The transceiver according to claim 1,
wherein the transceiver is configured to receive a control information describing the at least two component carriers out of the plurality of component carriers of the virtual resource pool to be used by the transceiver for carrier aggregation,
wherein the at least two component carriers are selected out of the plurality of component carriers of the virtual resource pool based on a selection criterion,
wherein the transceiver is configured to select the at least two component carriers described by the control information.

16. The transceiver according to claim 1,
wherein the transceiver is configured to perform a first proper subset of periodic transmissions using a first component carrier or virtual resource pool or virtual bandwidth part and to perform a second proper subset of the periodic transmissions following the first proper subset of periodic transmissions using a second component carrier or virtual resource pool or virtual bandwidth part.

17. The transceiver according to claim 1,
wherein a transmission on the first component carrier or virtual resource pool or virtual bandwidth part comprises an information describing the second component carrier or virtual resource pool or virtual bandwidth part.

18. The transceiver according to claim 1,
wherein the virtual resource pool comprises one or more exceptional resource pools.

19. A method for transmitting or receiving signals in a wireless communication network, wherein the method comprises:
transmitting or receiving a signal via a sidelink of the wireless communication network in a virtual resource pool of the sidelink, the virtual resource pool comprising a plurality of component carriers and/or two or more resource pools,
wherein a first type of information is transmitted using a first component carrier or virtual resource pool or virtual bandwidth part and at least a part of a second type of information is simultaneously transmitted or received using a second component carrier or virtual resource pool or virtual bandwidth part,
wherein the first type of information is feedback information,
wherein the second type of information is feedback information.

20. A non-transitory digital storage medium having a computer program stored thereon to perform the method for transmitting or receiving signals in a wireless communication network, wherein the method comprises:
transmitting or receiving a signal via a sidelink of the wireless communication network in a virtual resource pool of the sidelink, the virtual resource pool comprising a plurality of component carriers and/or two or more resource pools,
wherein a first type of information is transmitted using a first component carrier or virtual resource pool or virtual bandwidth part and at least a part of a second type of information is simultaneously transmitted or received using a second component carrier or virtual resource pool or virtual bandwidth part,
wherein the first type of information is feedback information,
wherein the second type of information is feedback information,
when said computer program is run by a computer.
